(19) United States
(12) Patent Application Publication
(10) Pub. No.: US 2026/0197827 A1
(43) Pub. Date: Jul. 9, 2026

(54) RADIO ACCESS NETWORK NODE, CORE NETWORK NODE, RADIO TERMINAL, AND METHODS THEREFOR

(71) Applicant: NEC Corporation, Minato-ku, Tokyo (JP)

(72) Inventors: Tomu TAMURA, Tokyo (JP); Atsushi NAKATA, Tokyo (JP)

(73) Assignee: NEC Corporation, Minato-ku, Tokyo (JP)

(21) Appl. No.: 18/864,084

(22) PCT Filed: May 25, 2023
(86) PCT No.: PCT/JP2023/019587

§ 371 Date: Nov. 8, 2024

(30) Foreign Application Priority Data
Jun. 2, 2022 (JP) 2022-090224

(51) Int. Cl. H04W 72/20

(52) U.S. Cl. CPC H04W 72/20

(57) ABSTRACT

A radio access network (RAN) node (1) receives from a core network (4) a first control message (201) containing a first information element relating to a radio terminal (3). The first information element indicates at least one of the following: an amount of data available to the radio terminal (3); or whether or not one or both of carrier aggregation and dual connectivity are required or allowed with respect to the radio terminal (3). This can help, for example, to provide a RAN node with useful information for determining whether carrier aggregation (CA), dual connectivity (DC), or handover is required for a radio terminal.

### TECHNICAL FIELD

The present disclosure relates to radio communication systems and, in particular, to connection management or mobility management of radio terminals.

### BACKGROUND ART

In a fifth-generation mobile communication system (5G system), a radio access network (RAN) can receive from a core network a per Session Aggregate Maximum Bit Rate (Session-AMBR), a per User Equipment (UE) Aggregate Maximum Bit Rate (UE-AMBR), and a per UE per Slice-Maximum Bit Rate (UE-Slice-MBR) (see, for example, Non-Patent Literature 1 and 2). Each of the Session-AMBR, the UE-AMBR, and the UE-Slice-MBR contains a value for the uplink (UL) and a value for the downlink (DL).

The Session-AMBR limits the aggregate bit rate that can be expected to be provided across all non-Guaranteed Bit Rate (non-GBR) Quality of Service (QOS) Flows for a specific Protocol Data Unit (PDU) Session. The RAN uses a Session-AMBR to calculate its UE-AMBR.

The UE-AMBR limits the aggregate bit rate that can be expected to be provided across all Non-GBR QOS Flows of a radio terminal (UE). The RAN enforces the UE-AMBR for Non-GBR QOS Flows in the UL and DL per UE. The RAN sets its UE-AMBR to the sum of the Session-AMBR of all PDU Sessions with active user plane to this RAN, up to the UE-AMBR received from the core network.

The UE-Slice-MBR limits the aggregate bit rate that can be expected to be provided across all GBR and non-GBR QOS Flows corresponding to PDU Sessions of the UE for the same network slice (Single Network Slice Selection Assistance Information (S-NSSAI)) that have active user plane. If the supporting RAN receives for the UE a UE-Slice-MBR for an S-NSSAI from the core network, the RAN applies this UE-Slice-MBR, if feasible, to all PDU Sessions of the UE corresponding to this S-NSSAI that have active user plane.

The Master Node (MN) of Dual Connectivity (DC) can determine the Session-AMBR limit, UE-AMBR limit, and UE-Slice-MBR limit to be assigned to a Secondary Node (SN) of the DC, and send them to the SN (see, for example, Non-Patent Literature 3 and 4).

### CITATION LIST

### Non Patent Literature

[Non-Patent Literature 1] 3GPP TS 23.501 V 17.4.0 (2022 March) “3rd Generation Partnership Project; Technical Specification Group Services and System Aspects; System architecture for the 5G System (5GS); Stage 2 (Release 17)”, March 2022
[Non-Patent Literature 2] 3GPP TS 38.413 V 17.0.0 (2022 April) “3rd Generation Partnership Project; Technical Specification Group Radio Access Network; NG-RAN; NG Application Protocol (NGAP) (Release 17)”, April 2022
[Non-Patent Literature 3] 3GPP TS 37.340 V 17.0.0 (2022 March) “3rd Generation Partnership Project; Technical Specification Group Radio Access Network; Evolved Universal Terrestrial Radio Access (E-UTRA) and NR; Multi-connectivity; Stage 2 (Release 17)”, March 2022
[Non-Patent Literature 4] 3GPP TS 38.423 V 17.0.0 (2022 April) “3rd Generation Partnership Project; Technical Specification Group Radio Access Network; NG-RAN; Xn application protocol (XnAP) (Release 17)”, April 2022

### TECHNICAL PROBLEM

The inventors have studied the decision in a RAN node for Carrier Aggregation (CA), DC and handover, and have found various problems. One of these problems relates to providing useful information to the RAN node to determine whether CA, DC or handover is required for a UE. In particular, it may be preferable for a core network to be able to provide such information to the RAN node.

Another problem identified by the inventors relates to the use by a RAN node of maximum bit rate parameters (e.g., Session-AMBR, UE-AMBR, or UE-Slice-MBR) provided by a core network to determine whether CA, DC, or handover is required. For example, if the UE-AMBR for a UE is changed or updated for any reason, the core network provides the updated value of the UE-AMBR to the RAN node. If the updated value of the UE-AMBR is small, initiating new DC for the UE or continuing ongoing DC may result in wasteful consumption of RAN compute and radio resources. A similar issue may also occur in situations where the Session-AMBR or the UE-Slice-MBR is updated. A similar issue may also occur in situations in the situation where CA is initiated or continued. A similar issue may also occur in a handover situation. For example, if the updated value of the UE-AMBR for the UE is small, it may be beneficial to move this UE from a cell that supports high speed communication to another cell in order to make efficient use of radio resources.

One of the objects to be achieved by the example embodiments disclosed herein seek to achieve is to provide apparatuses, methods, and programs that contribute to solving at least one of a plurality of problems, including the problems described above. It should be noted that this object is only one of the objects to be achieved by the example embodiments disclosed herein. Other objects or problems and novel features will become apparent from the following description and the accompanying drawings.

### SOLUTION TO PROBLEM

In a first aspect, a radio access network node includes at least one memory and at least one processor coupled to the at least one memory. The at least one processor is configured to receive from a core network a first control message containing a first information element relating to a radio terminal. The first information element indicates at least one of: an amount of data available to the radio terminal; or whether or not one or both of carrier aggregation and dual connectivity are required or allowed with respect to the radio terminal.

In a second aspect, a method performed by a radio access network node includes receiving from a core network a first control message containing a first information element relating to a radio terminal. The first information element indicates at least one of: an amount of data available to the radio terminal; or whether or not one or both of carrier aggregation and dual connectivity are required or allowed with respect to the radio terminal.

In a third aspect, a core network node includes at least one memory and at least one processor coupled to the at least one memory. The at least one processor is configured to send to a radio access network node a first control message containing a first information element relating to a radio terminal. The first information element indicates at least one of: an amount of data available to the radio terminal; or whether or not one or both of carrier aggregation and dual connectivity are required or allowed with respect to the radio terminal.

In a fourth aspect, a method performed by a core network node includes sending to a radio access network node a first control message containing a first information element relating to a radio terminal. The first information element indicates at least one of: an amount of data available to the radio terminal; or whether or not one or both of carrier aggregation and dual connectivity are required or allowed with respect to the radio terminal.

In a fifth aspect, a radio terminal includes at least one memory and at least one processor coupled to the at least one memory. The at least one processor is configured to send to a core network a control message containing an information element indicating whether or not one or both of carrier aggregation and dual connectivity are required.

In a sixth aspect, a method performed by a radio terminal includes sending to a core network a control message containing an information element indicating whether or not one or both of carrier aggregation and dual connectivity are required.

In a seventh aspect, a radio access network node includes at least one memory and at least one processor coupled to the at least one memory. The at least one processor is configured to obtain one or more maximum bit rate parameters that limit an aggregate bit rate of a plurality of QoS flows with respect to a radio terminal. The at least one processor is configured to perform a determination of whether or not one or both of carrier aggregation and dual connectivity are required with respect to the radio terminal based on the one or more maximum bit rate parameters.

In an eighth aspect, a method performed by a radio access network node includes the steps of:
(a) obtaining one or more maximum bit rate parameters that limit an aggregate bit rate of a plurality of QoS flows with respect to a radio terminal; and
(b) performing a determination of whether or not one or both of carrier aggregation and dual connectivity are required with respect to the radio terminal based on the one or more maximum bit rate parameters.

In a ninth aspect, a radio access network node includes at least one memory and at least one processor coupled to the at least one memory. The at least one processor is configured to obtain one or more maximum bit rate parameters that limit an aggregate bit rate of a plurality of QoS flows with respect to a radio terminal. The at least one processor is configured to determine whether to hand over the radio terminal from a current serving cell to another cell based on the one or more maximum bit rate parameters.

In a tenth aspect, a method performed by a radio access network node includes the steps of:
(a) obtaining one or more maximum bit rate parameters that limit an aggregate bit rate of a plurality of QoS flows with respect to a radio terminal; and
(b) determining whether to hand over the radio terminal from a current serving cell to another cell based on the one or more maximum bit rate parameters.

In an eleventh aspect, a program includes a set of instructions (software codes) that, when loaded into a computer, cause the computer to perform the method according to one of the aspects described above.

### ADVANTAGEOUS EFFECTS OF INVENTION

According to the aspects described above, it is possible to provide apparatuses, methods, and programs that contribute to solving at least one of a plurality of problems related to CA, DC, and handover decisions by a RAN node, including the problems mentioned above.

### BRIEF DESCRIPTION OF DRAWINGS

FIG. 1 shows an example configuration of a radio communication system according to an example embodiment;

FIG. 2 is a sequence diagram showing an example of signaling according to an example embodiment;

FIG. 3 is a flowchart showing an example operation of a RAN node according to an example embodiment;

FIG. 4 is a flowchart showing an example operation of a RAN node according to an example embodiment;

FIG. 5 is a flowchart showing an example operation of a RAN node according to an example embodiment;

FIG. 6 is a flowchart showing an example operation of a RAN node according to an example embodiment;

FIG. 7 is a flowchart showing an example operation of a RAN node according to an example embodiment;

FIG. 8 is a flowchart showing an example operation of a RAN node according to an example embodiment;

FIG. 9 is a flowchart showing an example operation of a RAN node according to an example embodiment;

FIG. 10 is a flowchart showing an example operation of a RAN node according to an example embodiment;

FIG. 11 is a flowchart showing an example operation of a RAN node according to an example embodiment;

FIG. 12 is a flowchart showing an example operation of a RAN node according to an example embodiment;

FIG. 13 is a sequence diagram showing an example of signaling according to an example embodiment;

FIG. 14 is a flowchart showing an example operation of a core network node according to an example embodiment;

FIG. 15 is a flowchart showing an example operation of a RAN node according to an example embodiment;

FIG. 16 is a sequence diagram showing an example operation of a RAN node and a core network node according to an example embodiment;

FIG. 17 is a sequence diagram showing an example operation of two RAN nodes according to an example embodiment;

FIG. 18 is a flowchart showing an example operation of a RAN node according to an example embodiment;

FIG. 19 is a flowchart showing an example operation of a RAN node according to an example embodiment;

FIG. 20 is a flowchart showing an example operation of a RAN node according to an example embodiment;

FIG. 21 is a flowchart showing an example operation of a RAN node according to an example embodiment;

FIG. 22 is a flowchart showing an example operation of a RAN node according to an example embodiment;

FIG. 23 is a flowchart showing an example operation of a RAN node according to an example embodiment;

FIG. 24 is a flowchart showing an example operation of a RAN node according to an example embodiment;

FIG. 25 is a block diagram showing an example configuration of a RAN node according to an example embodiment;

FIG. 26 is a block diagram showing an example configuration of a radio terminal according to an example embodiment; and

FIG. 27 is a block diagram showing an example configuration of a core network node according to an example embodiment.

### EXAMPLE EMBODIMENT

Specific example embodiments will be described hereinafter in detail with reference to the drawings. Identical or corresponding elements are designated by the same symbols throughout the drawings, and duplicate explanations are omitted where necessary for the sake of clarity.

The multiple example embodiments described below may be implemented independently or in any suitable combination. These multiple example embodiments have novel features that differ from one another. Accordingly, these multiple example embodiments contribute to achieving different objectives or solving different problems and contribute to achieving different advantages.

The following example embodiments are described primarily with respect to the 3rd Generation Partnership Project (3GPP (registered trademark)) Long Term Evolution (LTE) system and the 5th generation mobile communication system (5G system). However, these example embodiments can be applied to other radio communication systems that support technologies similar to 3GPP CA, DC, and handover. The term LTE as used herein includes improvements and enhancements to LTE and LTE-Advanced to enable interworking with 5G systems, unless otherwise specified.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

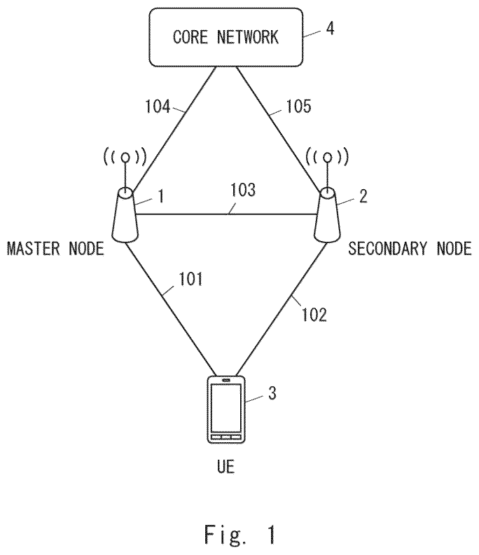

First, the configurations and operations of a plurality of network elements, which are common to a plurality of example embodiments, are described. FIG. 1 shows an example configuration of a radio communication system according to a plurality of example embodiments. In the example of FIG. 1, the radio communication system includes a RAN node 1, a RAN node 2, and a radio terminal 3. In the following, the radio terminal 3 is also referred to as a User Equipment (UE). Each element (network function) shown in FIG. 1 can be implemented, for example, as a network element on dedicated hardware, as a software instance running on dedicated hardware, or as a virtualized function instantiated on an application platform.

The RAN node 1 may be a Central Unit (e.g., eNB-CU, or gNB-CU) in a Cloud RAN (C-RAN) deployment, or a combination of a CU and one or more Distributed Units (e. g., eNB-DUs, or gNB-DUs). C-RAN is also known as CU/DU split. A CU can include a Control Plane (CP) Unit (e.g., gNB-CU-CP) and one or more User Plane (UP) Units (e.g., gNB-CU-UP). Accordingly, the RAN node 1 may be a CU-CP, or a combination of a CU-CP and a CU-UP(s). Similarly, the RAN node 2 may be a CU or a combination of a CU and one or more DUs. The RAN node 2 may be a CU-CP or a combination of a CU-CP and a CU-UP(s).

Each of the RAN nodes 1 and 2 may be an Evolved Universal Mobile Telecommunications System (UMTS) Terrestrial Radio Access Network (EUTRAN) node or a Next generation Radio Access Network (NG-RAN) node. The EUTRAN node can be an eNB or an en-gNB. The NG-RAN node can be a gNB or an ng-eNB. The en-gNB is a node that provides NR user plane and control plane protocol termination to the UE and acts as a secondary node (SN) for E-UTRA-NR Dual Connectivity (EN-DC). The ng-eNB is a node that provides E-UTRA user plane and control plane protocol termination to the UE and is connected to a 5GC via an NG interface. The Radio Access Technology (RAT) of the RAN node 1 may be different from that of the RAN node 2.

The RAN node 1 and the RAN node 2 may communicate with each other via an inter-node interface (i.e., X2 interface or Xn interface) 103. The RAN node 1 and the RAN node 2 may function as a Master Node (MN) and a Secondary Node (SN), respectively, for dual connectivity. In the following, the RAN node 1 is sometimes referred to as MN 1 and the RAN node 2 is sometimes referred to as SN 2. The radio terminal (UE) 3 can communicate with the MN 1 and the SN 2 via air interfaces 101 and 102 and perform dual connectivity of a Master Cell Group (MCG) and a Secondary Cell Group (SCG).

This dual connectivity may be Multi-Radio Dual Connectivity (MR-DC). MR-DC includes E-UTRA-NR Dual Connectivity (EN-DC), NG-RAN E-UTRA-NR Dual Connectivity (NGEN-DC), NR-E-UTRA Dual Connectivity (NE-DC), and NR-NR Dual Connectivity (NR-DC). Accordingly, the MN 1 can be a Master eNB (in EN-DC), a Master ng-eNB (in NGEN-DC), or a Master gNB (in NR-DC and NE-DC).

Similarly, the SN 2 can be an en-gNB (in EN-DC), a Secondary ng-eNB (in NE-DC), or a Secondary gNB (in NR-DC and NGEN-DC). In EN-DC, the UE 3 is connected to an eNB acting as the MN 1 and to an en-gNB acting as the SN 2. In NGEN-DC, the UE 3 is connected to an ng-eNB acting as the MN 1 and to a gNB acting as the SN 2. In NE-DC, the UE 3 is connected to a gNB acting as the MN 1 and to an ng-eNB acting as the SN 2. In NR-DC, the UE 3 is connected to one gNB (or gNB-DU) acting as the MN 1 and to another gNB (or gNB-DU) acting as the SN 2.

The MCG is a group of serving cells associated with (or provided by) the MN 1, and includes a Special Cell (SpCell) (i.e., a Primary Cell (PCell)) and, optionally, one or more Secondary Cells (SCells). On the other hand, an SCG is a group of serving cells associated with (or provided by) the SN 2, and includes a Primary SCG Cell (PSCell) and, optionally, one or more Secondary Cells (SCells). The PSCell is the SpCell of the SCG and supports Physical Uplink Control Channel (PUCCH) transmission and contention-based random access.

The term “primary SCG cell” and its abbreviation “PSCell” as used herein means a cell that is included in a cell group served by an SN in dual connectivity, has an uplink component carrier, and is configured with uplink control channel (e.g., PUCCH) resources. More specifically, the term “primary SCG cell” and its abbreviation “PSCell” may mean the Primary SCG cell of a cell group served by an SN (e.g., en-gNB in EN-DC, gNB in NGEN-DC, or gNB in NR-DC) that supports 5G NR, or it may mean the Primary SCell of a cell group served by an SN that supports E-UTRA (e. g., eNB in LTE DC, or ng-eNB in NE-DC).

The RAN node 1 communicates with a core network 4 via an interface 104. The RAN node 2 communicates with the core network 4 via an interface 105. The interface 104 includes a control plane interface (or connection) and a user plane interface (or connection).

The interface 105 includes a user plane interface and may include a control plane interface. The control plane interface may be an NG-C or S1-Mobility Management Entity (MME) interface. The user plane interface may be an NG-U or S1-U interface.

The core network 4 may be a 5G Core (5GC), an Evolved Packet Core (EPC), or a combination thereof. The core network 4 includes one or more core network nodes. These core network nodes include one or more control plane nodes and one or more user plane (or data plane) nodes. In the case of a 5G system, the control plane nodes include an Access and Mobility Management Function (AMF), a Session Management Function (SMF), and other nodes (e.g., a Unified Data Management (UDM) and a Policy Control Function (PCF)), while the user plane nodes include a User Plane Function (UPF). In the case of an LTE system, the control plane nodes include a Mobility Management Entity (MME) and other nodes (e.g., a Home Subscriber Server (HSS) and a Policy and Charging Rules Function (PCRF)), while the user plane nodes include a Serving Gateway (S-GW) and a Packet Data Network Gateway (P-GW).

The example configuration shown in FIG. 1 is only an example and can be modified as needed. For example, the MN and SN functions of dual connectivity can be provided by a single RAN node (e.g., RAN node 1). In particular, NR-DC can also be used in cases where the UE 3 is only connected to the RAN node 1 (i.e., gNB), which acts as both MN and SN and provides both MCG and SCG. In this case, the UE 3 may be connected to two gNB-DUs, one providing MCG and the other SCG, and these two gNB-DUs may be connected to a single gNB-CU acting as both MN and SN. Alternatively, the UE 3 may be connected to a single gNB-DU providing both MCG and SCG, and this gNB-DU may be connected to a single gNB-CU acting as both MN and SN.

This specification uses the terms MN Radio Resource Control (RRC) Reconfiguration message and SN RRC Reconfiguration message. These terms are used for convenience to distinguish RRC (Connection) Reconfiguration messages generated by the MN from RRC (Connection) Reconfiguration messages generated by the SN. An MN RRC Reconfiguration message may simply be referred to as an RRC Reconfiguration message or an RRC Connection Reconfiguration message. Similarly, an SN RRC Reconfiguration message may simply be referred to as an RRC Reconfiguration message or an RRC Connection Reconfiguration message.

### First Example Embodiment

This example embodiment provides improved signaling between a RAN and a core network, and RAN operation based on the improved signaling. An example configuration of a radio communication system according to this example embodiment may be the same as the example shown in FIG. 1.

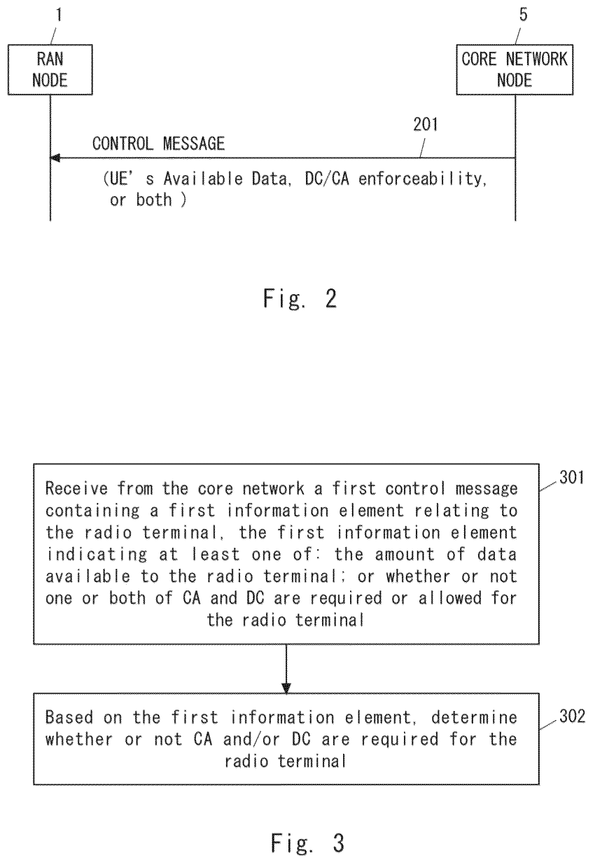

FIG. 2 shows an example of signaling between the RAN node 1 and a core network node 5. The core network node 5 is a control plane node included in the core network 4. If the core network 4 is a 5GC, the core network node 5 may be an AMF or an SMF or a combination thereof, and the signaling may be NG Application Protocol (NGAP) signaling or an NGAP message. If the core network 4 is an EPC, the core network node 5 may be an MME, and the signaling may be SIAP signaling or an SIAP message.

In step 201, the core network node 5 sends to the RAN node 1 a first control message containing a first information element relating to the radio terminal 3. The first control message may be an NGAP message or an SIAP message. The first information element indicates at least one of: the amount of data available to the radio terminal 3; or whether or not one or both of CA and DC are required (or allowed) with respect to the radio terminal 3.

The core network node 5 may send the first control message containing the first information element in a case where a control connection related to the radio terminal 3 is newly established between the core network node 5 and the RAN node 1. In this case, the first control message may be an NGAP: INITIAL CONTEXT SETUP REQUEST message. Additionally or alternatively, in response to information contained in the first information element being updated or modified, the core network node 5 may send a first control message containing the updated first information element. In this case, the first control message may be an NGAP: UE CONTEXT MODIFICATION REQUEST message. Additionally or alternatively, the core network node 5 may send the first control message containing the first information element in a case where a PDU Session is established for the radio terminal 3. In this case, the first control message may be an NGAP: PDU SESSION RESOURCE SETUP REQUEST message.

The first information element may at least indicate the amount of data available to the radio terminal 3. In this case, the name of the first information element is, for example, but not limited to, a “UE's Available Data” information element. The information element may be of integer type and may have an integer value between 0 and 1,000,000,000,000, for example, to indicate the size (in bytes) of the amount of data.

The amount of data available to the radio terminal 3 may be the remaining amount of data available to the user (or subscriber) using the radio terminal 3 until the end of the current month. In other words, the amount of data available to the radio terminal 3 may indicate the remaining amount of data up to the monthly data limit based on the contract (or subscription). Alternatively, the amount of data available to the radio terminal 3 may indicate the remaining amount of data that the user of the radio terminal 3 can consume during a predetermined time period (e.g., 3 days, 1 week, 1 month).

The first information element may at least indicate whether or not one or both of CA and DC are required (or allowed) with respect to the radio terminal 3. In this case, the name of the first information element may be, for example, but is not limited to, an “NR-DC/CA Enforceability” information element. This information element may be of enumerated type, and may indicate “NR-DC & CA Enforceable”, “Only NR-DC Enforceable”, “Only CA Enforceable”, or “NR-DC & CA Not Enforceable”.

In some implementations, depending on a communication status of the user of the radio terminal 3, the core network node 5 may provide the RAN node 1 with an (updated) first information element indicating that one or both of CA and DC are not required or allowed with respect to the radio terminal 3. Specifically, if it is detected that the user of the radio terminal 3 is about to use up the data volume that can be used or consumed in a predetermined time period (e.g., 3 days, 1 week, 1 month), the core network node 5 may provide the RAN node 1 with an (updated) first information element indicating that one or both of CA and DC are not required or not allowed for the radio terminal 3. Alternatively, if it is detected that the user of the radio terminal 3 has exhausted the data volume that can be used or consumed within a predetermined time period (e.g., 3 days, 1 week, 1 month), the core network node 5 may provide the RAN node 1 with an (updated) first information element indicating that one or both of CA and DC are not required or not allowed for the radio terminal 3. On the other hand, if the data volume available to the user of the radio terminal 3 is restored for reasons such as entering a new predetermined time period, the core network node 5 may provide the RAN node 1 with an (updated) first information element indicating that one or both of CA and DC are required or allowed for the radio terminal 3.

In some implementations, depending on other causes such as congestion in the core network 4, the core network node 5 may provide the (updated) first information element to the RAN node 1 indicating that one or both of CA and DC are not required or allowed with respect to the radio terminal 3.

The first information element may be used by the RAN node 1 to determine whether or not one or both of CA and DC are required for the radio terminal 3. Specifically, the RAN node 1 may determine whether or not to perform or initiate one or both of CA and DC for the radio terminal 3 based on, depending on, using, or taking into account the first information element. Additionally or alternatively, the RAN node 1 may determine whether or not to stop one or both of an ongoing CA and DC for the radio terminal 3, based on, depending on, using, or considering the first information element.

CA can be initiated by adding or configuring one or more SCells, or by activating (or enabling) one or more SCells that have already been added or configured. The addition and release of an SCell(s) can be performed by the RAN node 1 sending an RRC (Connection) Reconfiguration message to the radio terminal 3. The activation of an SCell(s) can be performed by the RAN node 1 sending an SCell Activation/Deactivation Medium Access Control (MAC) Control Element (CE) to the radio terminal 3.

CA can be stopped by releasing one or more SCells, or by deactivating (or disabling) one or more SCells. The release of an SCell(s) may be performed by the RAN node 1 sending an RRC (Connection) Reconfiguration message to the radio terminal 3. The deactivation of an SCell(s) may be performed by the RAN node 1 sending an SCell Activation/Deactivation MAC CE to the radio terminal 3. The RAN node 1 may provide the radio terminal 3 with an updated measurement configuration via an RRC (Connection) Reconfiguration message, so that the frequency of the released SCell(s) is excluded from the measurement objects of the radio terminal 3.

DC can be initiated by adding or configuring a new SN or SCG, or by activating (or enabling) an already added or configured SCG. The addition of an SN or SCG can be initiated by the MN (e.g., RAN node 1) by initiating an SN addition procedure. This SN Addition procedure includes the transmission of an S-NODE ADDITION REQUEST message from the MN (e.g., RAN node 1) to the SN (e.g., RAN node 2). This SN Addition procedure also includes the transmission of an MN RRC Reconfiguration message from the RAN node 1 to the radio terminal 3 containing an SN RRC configuration message generated by the RAN node 2. The activation of the SCG can be performed by sending an RRC message, MAC CE, or Downlink Control Information (DCI) from the MN (e.g., RAN node 1) or the SN (e.g., RAN node 2) to the radio terminal 3.

DC can be stopped by releasing the SN and SCG, or by deactivating (or inactivating) the SCG. The release of the SN and SCG can be performed by the MN (e.g., RAN node 1) initiating an SN release procedure. The SN release procedure involves the transmission of an S-NODE RELEASE REQUEST message from the MN (e.g., RAN node 1) to the SN (e.g., RAN node 2). In the SN release procedure, the MN (e.g., RAN node 1) may, if necessary, indicate to the radio terminal 3 in an MN RRC Reconfiguration message that the radio terminal 3 should release all SCG configurations. The MN (e.g., RAN node 1) may provide the radio terminal 3 with an updated measurement configuration via an RRC (Connection) Reconfiguration message, so that the released SCG frequency is excluded from the measurement objects of the radio terminal 3.

In the SN release procedure, the MN (e.g., RAN node 1) may include in the S-NODE RELEASE REQUEST message a Cause information element indicating the cause of the SN release. This Cause information element may be set to a value indicating, for example, that the radio terminal 3 is about to use up the data volume based on the contract, or that the radio terminal 3 has exhausted the data volume based on the contract. For example, this Cause information element may be set to “UE available data reaches maximum”.

Consider the case where the first information element indicates the amount of data available to the radio terminal 3. In this case, if the amount of data is below a first threshold value, the RAN node 1 may determine or recognize that it will not perform (or initiate) CA and/or DC for the radio terminal 3. Similarly, if the amount of data is below a first threshold value, the RAN node 1 may stop an ongoing CA and/or DC for the radio terminal 3. On the other hand, if the amount of data is greater than a second threshold value, the RAN node 1 may determine or recognize that it is allowed to perform (or initiate) CA and/or DC for the radio terminal 3. Similarly, if the amount of data is greater than a second threshold value, the RAN node 1 may continue an ongoing CA and/or DC for the radio terminal 3. The second threshold value may be the same as or different from the first threshold value.

Consider the case where the first information element indicates whether or not one or both of CA and DC are required (or allowed) with respect to the radio terminal 3. In this case, if the first information element indicates that one or both of CA and DC are unnecessary or prohibited, the RAN node 1 may determine or recognize that it will not perform (or initiate) CA and/or DC for the radio terminal 3. Alternatively, the RAN node 1 may stop an ongoing CA and/or DC for the radio terminal 3. On the other hand, if the first information element indicates that one or both of CA and DC are required or allowed, the RAN node 1 may determine or recognize that it is allowed to perform (or initiate) CA and/or DC for the radio terminal 3. Alternatively, the RAN node 1 may continue an ongoing CA and/or DC for the radio terminal 3.

The first information element may be used by the RAN node 1 to determine whether or not to hand over the radio terminal 3 from the current serving cell to another cell. Specifically, the RAN node 1 may determine whether or not to hand over the radio terminal 3 based on, depending on, using, or taking into account the first information element.

Consider the case where the first information element indicates the amount of data available to the radio terminal 3. In this case, if the amount of data is below a first threshold value, the RAN node 1 may decide to hand over the radio terminal 3 from the current serving cell supporting high-speed communication to another cell. On the other hand, if the amount of data is greater than a second threshold value, the RAN node 1 may decide to hand over the radio terminal 3 from the current serving cell to another cell supporting high-speed communication. The second threshold value may be the same as or different from the first threshold value. For example, cells supporting high-speed communication may be cells operating in a millimeter wave (mm Wave) (FR2) band, while other cells may be sub-6 GHZ (FR1) band. Alternatively, cells supporting high-speed communication may be 5G New Radio (NR) cells, while other cells may be LTE cells.

The first information element may be used by the RAN node 1 to derive a second information element to be transmitted to the RAN node 2. In particular, the RAN node 1 acting as the MN of a DC for the radio terminal 3 may derive the second information element based on the first information element and send a second control message containing the second information element to the RAN node 2 acting as the SN of the DC. For example, the RAN node 1 may divide the amount of data indicated by the first information element received from the core network node 5 into the amount of data to be assigned to the MN and the amount of data to be assigned to the SN. The RAN node 1 may then generate a second information element indicating the amount of data to be assigned to the SN, and send a second control message containing the second information element to the RAN node 2 acting as the SN. In another example, the RAN node 1 may transparently include the information indicated by the first information element received from the core network node 5 in the second information element. In other words, the RAN node 1 may include the information indicated by the first information element received from the core network node 5 in the second information element without modification.

The signaling described with reference to FIG. 2 allows useful information to be provided to the RAN node 1 to determine whether or not CA, DC, or handover is required with respect to the radio terminal 3.

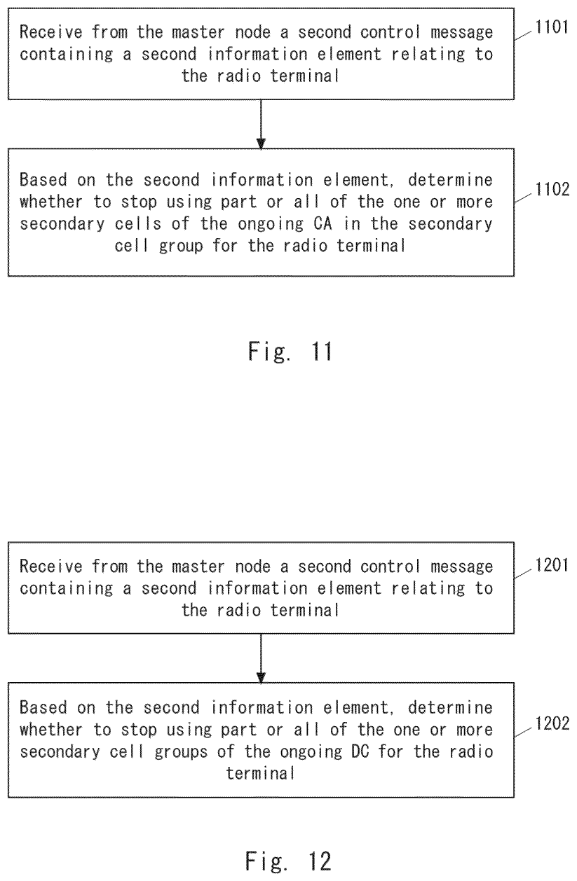

FIGS. 3 to 10 show examples of the operation of the RAN node 1, and FIGS. 11 and 12 show examples of the operation of the RAN node 2. The following describes examples of the operation of the RAN node 1 and 2 with reference to these figures.

FIG. 3 shows an example of the operation of the RAN node 1. Step 301 corresponds to step 201 in FIG. 2. Specifically, in step 301, the RAN node 1 receives from the core network 4 a first control message containing a first information element relating to the radio terminal 3. The first information element indicates at least one of: the amount of data available to the radio terminal 3; or whether or not one or both of CA and DC are required (or allowed) with respect to the radio terminal 3.

In step 302, the RAN node 1 determines whether or not one or both of CA and DC are required for the radio terminal 3 based on the first information element. In other words, the RAN node 1 determines whether or not CA and/or DC are required for the radio terminal 3 based on, depending on, using, or taking into account the information provided in the first information element. Since the method of this determination has already been explained, a detailed explanation is omitted here.

If DC is not required for the radio terminal 3, the RAN node 1 may not initiate DC for the radio terminal 3, or may stop an ongoing DC for the radio terminal 3. If CA is not required for the radio terminal 3, the RAN node 1 may not initiate CA for the radio terminal 3, or may stop an ongoing CA for the radio terminal 3.

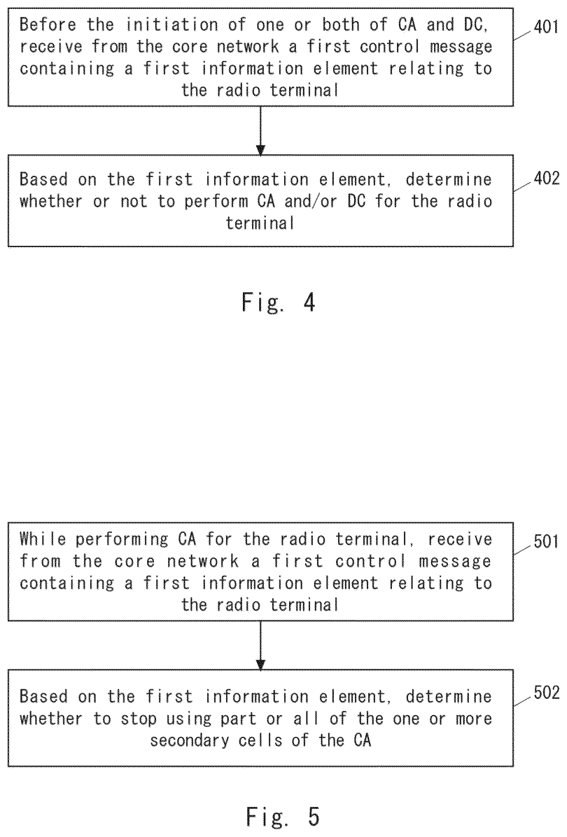

FIG. 4 shows an example of the operation of the RAN node 1. Step 401 is the same as step 301 in FIG. 3.

In step 402, the RAN node 1 determines whether or not to perform (or initiate) one or both of CA and DC for the radio terminal 3 based on the first information element. In other words, the RAN node 1 determines whether or not to perform (or initiate) CA and/or DC for the radio terminal 3 based on, depending on, using, or taking into account the information provided in the first information element. Since the method of this determination has already been explained, a detailed explanation is omitted here.

FIG. 5 shows an example of the operation of the RAN node 1. Step 501 is the same as step 301 in FIG. 3. However, in step 501, while the RAN node 1 is performing CA for the radio terminal 3, the RAN node 1 receives the first control message containing the first information element from the core network 4.

In step 502, the RAN node 1 determines, based on the first information element, whether to stop the use of part or all of one or more SCells of the ongoing CA for the radio terminal 3. The method of this determination may be the same as any of the methods described above. A plurality of threshold values may be used to make this determination. More specifically, consider the case where the first information element indicates the amount of data available to the radio terminal 3. In this case, if the amount of data is less than a first threshold value, the RAN node 1 may release (or deactivate) some of the SCells that have been configured (or activated) in the CA. If the amount of data is less than a second threshold value, which is less than the first threshold value, the RAN node 1 may release (or deactivate) all the SCells that have been configured (or activated) in the CA.

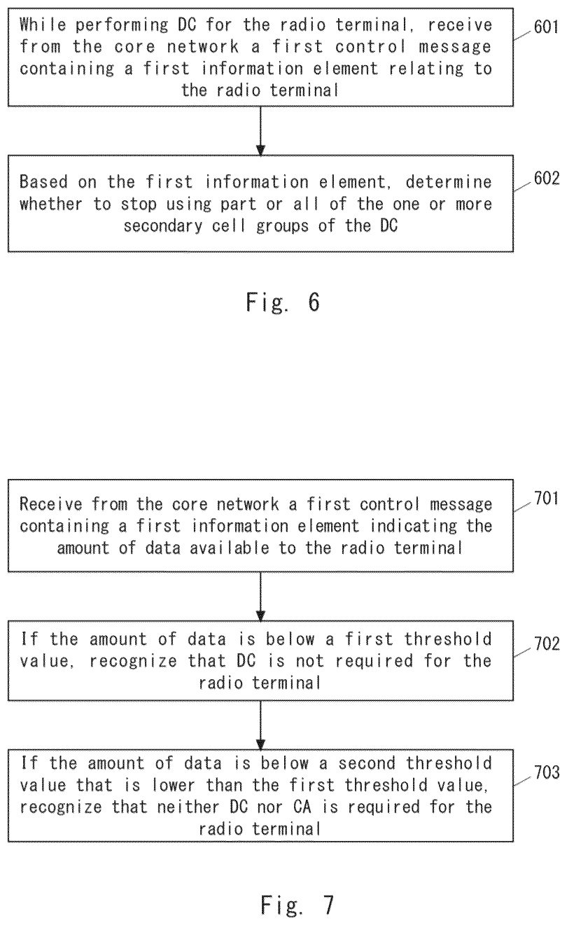

FIG. 6 shows an example of the operation of the RAN node 1. Step 601 is the same as step 301 in FIG. 3. However, in step 601, while the RAN node 1 is performing DC for the radio terminal 3, the RAN node 1 receives the first control message containing the first information element from the core network 4.

In step 602, the RAN node 1 determines, based on the first information element, whether to stop the use of part or all of one or more SCGs of the ongoing DC for the radio terminal 3. The method of this determination may be the same as any of the methods described above. A plurality of threshold values may be used to make this determination. More specifically, consider the case where the first information element indicates the amount of data available to the radio terminal 3. In this case, if the amount of data is less than a first threshold value, the RAN node 1 may release (or deactivate) some of the SCGs that have been configured (or activated) in the DC. If the amount of data is less than a second threshold value, which is less than the first threshold value, the RAN node 1 may release (or deactivate) all the SCGs that have been configured (or activated) in the DC.

FIG. 7 shows an example of the operation of the RAN node 1. Step 701 is the same as step 301 in FIG. 3. However, in step 701, the first information element at least indicates the amount of data available to the radio terminal 3.

In step 702, if the amount of data indicated by the first information element is less than a first threshold value, the RAN node 1 determines or recognizes that DC is not required for the radio terminal 3. In step 703, if the amount of data indicated by the first information element is less than a second threshold value, which is less than the first threshold value, the RAN node 1 determines or recognizes that neither DC nor CA is required for the radio terminal 3. The sequence of steps 702 and 703 is not restricted. Steps 702 and 703 may be performed substantially simultaneously, or step 703 may be performed before step 702.

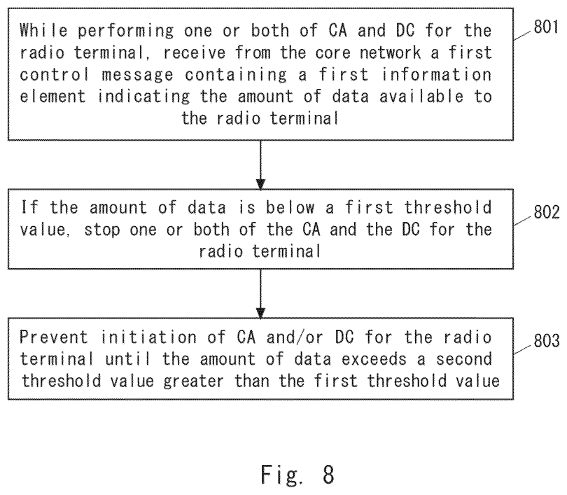

FIG. 8 shows an example of the operation of the RAN node 1. Step 801 is the same as step 301 in FIG. 3. However, in step 801, while the RAN node 1 is performing one or both of CA and DC for the radio terminal 3, the RAN node 1 receives the first control message containing the first information element from the core network 4. In addition, in step 801, the first information element at least indicates the amount of data available to the radio terminal 3.

In step 802, if the amount of data indicated by the first information element is less than a first threshold value, the RAN node 1 stops the CA and/or the DC for the radio terminal 3.

In step 803, the RAN node 1 prevents initiation of one or both of the CA and the DC for the radio terminal 3 until the amount of data exceeds a second threshold value that is greater than the first threshold value. In other words, the RAN node 1 stops the CA and/or the DC for the radio terminal 3 until it receives a new control message from the core network 4 indicating an updated value of the amount of data exceeding the second threshold value.

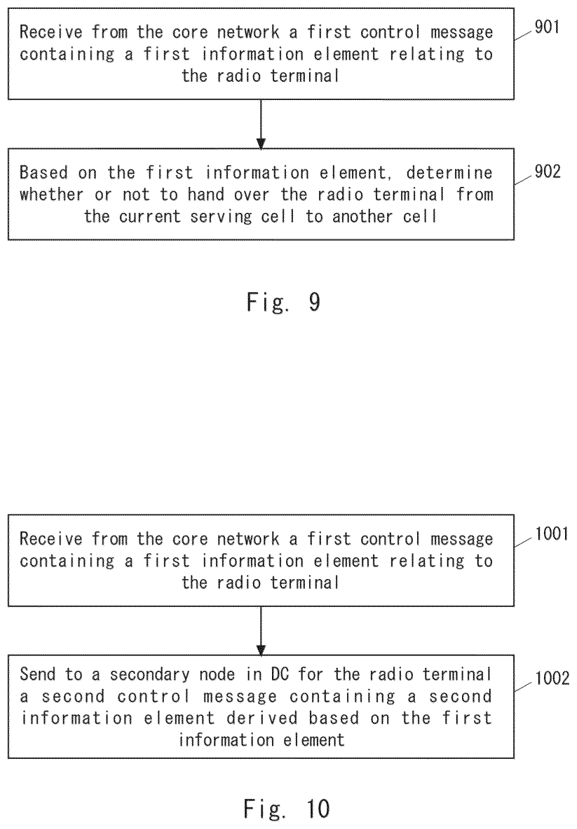

FIG. 9 shows an example of the operation of the RAN node 1. Step 901 is the same as step 301 in FIG. 3.

In step 902, the RAN node 1 determines whether or not to hand over the radio terminal 3 from the current serving cell to another cell based on the first information element. The method of this determination may be the same as any of the methods described above.

FIG. 10 shows an example of the operation of the RAN node 1. Step 1001 is the same as step 301 in FIG. 3.

In step 1002, the RAN node 1 operating as the MN sends a second control message containing a second information element derived based on the first information element to the RAN node 2 operating as an SN of the DC for the radio terminal 3. Note that the “RAN node 1 operating as the MN” may be a RAN node that is capable of operating as the MN, i.e., it may be a candidate for the MN before the DC is initiated. Alternatively, the “RAN node 1 operating as the MN” may be a RAN node that is actually operating as the MN after the DC has initiated. Similarly, the “RAN node 2 operating as an SN” may be a RAN node that is capable of operating as an SN, i.e., it may be a candidate for an SN before the DC is initiated. Alternatively, the “RAN node 2 operating as an SN” may be a RAN node that is actually operating as an SN after the DC has initiated. The method of deriving or generating the second information element may be the same as any of the methods already described. The second control message may be an XnAP message. More specifically, the second control message may be an XnAP: S-NODE ADDITION REQUEST message or an XnAP: S-NODE MODIFICATION REQUEST message.

FIG. 11 shows an example of the operation of the RAN node 2. In step 1101, the RAN node 2 operating as a SN of a DC receives from the RAN node 1 operating as the MN a second control message containing a second information element relating to the radio terminal 3.

In step 1102, the RAN node 2 determines, based on the second information element, whether or not to stop the use of part or all of the one or more SCells of the CA executed in the SCG for the radio terminal 3. The method of this determination may be the same as any of the methods already described for the CA in the RAN node 1.

FIG. 12 shows an example of the operation of the RAN node 2. In step 1201, the RAN node 2 operating as an SN of a DC receives from the RAN node 1 operating as the MN a second control message containing a second information element relating to the radio terminal 3.

In step 1202, based on the second information element, the RAN node 2 determines whether or not to stop the use of part or all of the one or more SCGs of the ongoing DC for the radio terminal 3. The method of this determination may be the same as any of the methods already described for the DC at the RAN node 1. If the decision is made to stop using an SCG, the RAN node 2 may deactivate (or disable) that SCG. Additionally or alternatively, if the decision is made to stop using an SCG, the RAN node 2 may request that the RAN node 1 operating as the MN to release that SCG.

### Second Example Embodiment

This example embodiment provides modifications to the first example embodiment. An example configuration of a radio communication system according to this example embodiment may be the same as the example explained with reference to FIG. 1.

FIG. 13 shows an example of signaling between the radio terminal 3 and the core network node 5. In step 1301, the radio terminal 3 sends to the core network node 5 a control message containing an information element indicating whether or not one or both of CA and DC are required. The name of the information element is, for example, but not limited to, a “DC/CA Necessity” information element.

If the core network 4 is a 5GC, the core network node 5 may be an AMF, an SMF, or a combination thereof. In this case, the control message in step 1301 may be a Non-Access Stratum (NAS) message. More specifically, the control message may be a REGISTRATION REQUEST message, a SERVICE REQUEST message, or a UL NAS TRANSPORT message sent from the radio terminal (UE) 3 to the AMF. Alternatively, the control message may be a PDU SESSION ESTABLISHMENT REQUEST message or a PDU SESSION MODIFICATION REQUEST message sent from the radio terminal (UE) 3 to the SMF. Each of the PDU SESSION ESTABLISHMENT REQUEST and PDU SESSION MODIFICATION REQUEST messages used for session management is sent from the radio terminal 3 to the AMF via a UL NAS TRANSPORT message and forwarded by the AMF to the SMF.

In requesting a registration with the core network 4, the radio terminal 3 may send the control message of step 1301 (e.g., REGISTRATION REQUEST message). Additionally or alternatively, in requesting the establishment of a secure connection with the AMF, the radio terminal 3 may send the control message of step 1301 (e.g., SERVICE REQUEST message). Additionally or alternatively, in requesting the establishment of a PDU Session, the radio terminal 3 may send the control messages of step 1301 (e.g., UL NAS TRANSPORT message and PDU SESSSION ESTABLISHMENT REQUEST message).

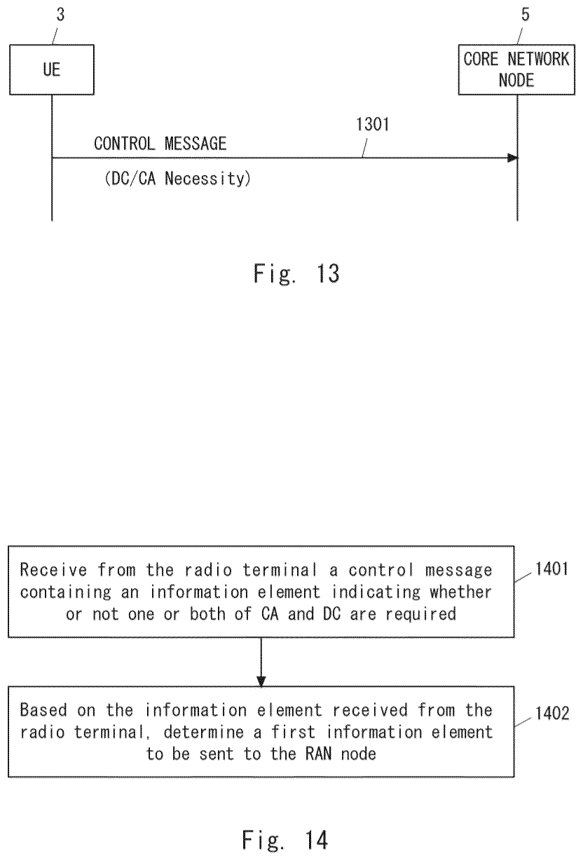

The information element carried in the control message of step 1301 may be used by the core network node 5 to inform the RAN node 1 whether or not one or both of CA and DC are required or allowed with respect to the radio terminal 3. More specifically, as shown in FIG. 14, the core network node 5 may determine or generate the first information element described in the first example embodiment based on, depending on, using, or taking into account the information element (e.g., DC/CA Necessity) received from the radio terminal 3.

FIG. 14 shows an example of the operation of the core network node 5. Step 1401 corresponds to step 1301 in FIG. 13. Specifically, the core network node 5 receives from the radio terminal 3 a control message containing an information element indicating whether or not CA and/or DC are required. In step 1402, the core network node 5 determines the first information element to be sent to the RAN node 1 based on the information element received from the radio terminal 3.

Specifically, if the information element from the radio terminal 3 indicates that CA is not required, the core network node 5 may provide the RAN node 1 with the first information element indicating that CA is not required or allowed for the radio terminal 3. On the other hand, if the information element from the radio terminal 3 indicates that CA is required, the core network node 5 may provide the RAN node 1 with the first information element indicating that CA is required or allowed for the radio terminal 3.

Additionally or alternatively, if the information element from the radio terminal 3 indicates that DC is not required, the core network node 5 may provide the RAN node 1 with the first information element indicating that DC is not required or allowed for the radio terminal 3. On the other hand, if the information element from the radio terminal 3 indicates that DC is required, the core network node 5 may provide the RAN node 1 with the first information element indicating that DC is required or allowed for the radio terminal 3.

The signaling and the operation of the radio terminal 3 and the core network node 5 described in this example embodiment allows the radio terminal 3 to inform the core network node 5 of whether or not CA and/or DC are required. The core network node 5 can inform the RAN node 1 whether or not CA and/or DC are required (or allowed) for the radio terminal 3, taking into account whether or not CA and/or DC are required by the radio terminal 3.

### Third Example Embodiment

This example embodiment provides improvements in the operation of a RAN node. An example configuration of a radio communication system according to this example embodiment may be the same as the example shown in FIG. 1.

FIG. 15 shows an example of the operation of the RAN node 1. The operation of FIG. 15 can be performed by the RAN node 2 acting as an SN of DC for the radio terminal 3. In step 1501, the RAN node 1 or 2 obtains one or more maximum bit rate parameters that limit an aggregate bit rate of a plurality of QoS Flows for the radio terminal 3. In step 1502, based on the one or more maximum bit rate parameters, the RAN node 1 or 2 determines whether or not one or both of CA and DC are required for the radio terminal 3.

The one or more maximum bit rate parameters may include an Aggregate Maximum Bit Rate per radio terminal, an Aggregate Maximum Bit Rate per PDU Session of the radio terminal 3, or a Maximum Bit Rate per network slice of the radio terminal 3, or any combination thereof. More specifically, the one or more maximum bit rate parameters may be a per User Equipment (UE) Aggregate Maximum Bit Rate (UE-AMBR), a per Session Aggregate Maximum Bit Rate (Session-AMBR), a per UE per Slice-Maximum Bit Rate (UE-Slice-MBR), or any combination thereof. Each of the Session-AMBR, the UE-AMBR, and the UE-Slice-MBR contains a value for the uplink (UL) and a value for the downlink (DL).

The Session-AMBR limits the aggregate bit rate that can be expected to be provided across all non-GBR QOS Flows for a specific PDU Session. The RAN node 1 uses a Session-AMBR to calculate its UE-AMBR.

The UE-AMBR limits the aggregate bit rate that can be expected to be provided across all Non-GBR QOS Flows of the radio terminal 3 (UE). The RAN node 1 enforces the UE-AMBR for Non-GBR QOS Flows in the UL and DL per UE. The RAN node 1 sets its UE-AMBR to the sum of the Session-AMBR of all PDU Sessions with active user plane to the RAN (e. g., RAN node 1 and 2), up to the UE-AMBR received from the core network 4.

The UE-Slice-MBR limits the aggregate bit rate that can be expected to be provided across all GBR and non-GBR QOS Flows corresponding to PDU Sessions of the radio terminal 3 (UE) for the same network slice (S-NSSAI) that have active user plane. If the supporting RAN receives for the UE a UE-Slice-MBR for an S-NSSAI from the core network 4, the RAN node 1 applies this UE-Slice-MBR, if feasible, to all PDU Sessions of the radio terminal 3 (UE) corresponding to this S-NSSAI that have active user plane.

The RAN node 1 may receive the one or more maximum bit rate parameters from the core network 4 via one or more control messages.

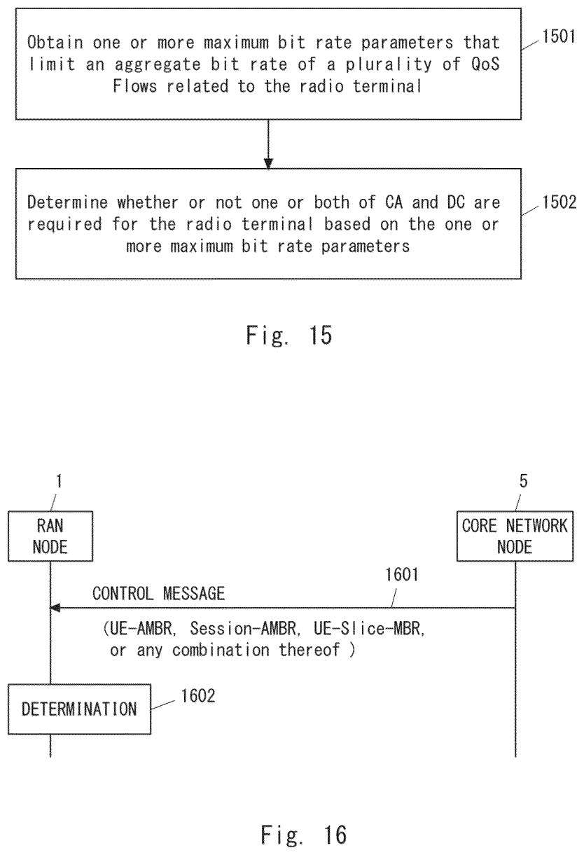

FIG. 16 shows a sequence diagram showing an example of the operation of the RAN node 1 and the core network node 5. The core network node 5 is a control plane node included in the core network 4. If the core network 4 is a 5GC, the core network node 5 may be an AMF, an SMF, or a combination thereof, and the signaling may be NG Application Protocol (NGAP) signaling or an NGAP message. If the core network 4 is an EPC, the core network node 5 may be an MME, and the signaling may be SIAP signaling or an SIAP message.

In step 1601, the RAN node 1 (e.g., gNB or ng-eNB) receives one or more maximum bit rate parameters from the core network node 5 (e.g., AMF or SMF) via one or more control messages. The one or more maximum bit rate parameters may be a UE-AMBR, a Session-AMBR, a UE-Slice-MBR, or any combination thereof. Each of the one or more control messages may be an NGAP message. Specifically, each of the one or more control messages may be an INITIAL CONTEXT SETUP REQUEST message, a UE CONTEXT MODIFICATION REQUEST message, a PDU SESSION RESOURCE SETUP REQUEST message, or a PDU SESSION RESOURCE MODIFY REQUEST message.

In step 1602, the RAN node 1 determines whether or not one or both of CA and DC are required for the radio terminal 3 based on the one or more maximum bit rate parameters received from the core network node 5.

In some implementations, the core network node 5 may provide the RAN node 1 with a UE-AMBR, a Session-AMBR, a UE-Slice-MBR, or any combination thereof, which is updated depending on a communication status of the user of the radio terminal 3. Specifically, if it is detected that the user of the radio terminal 3 is about to use up the data volume that can be used or consumed in a predetermined time period (e.g., 3 days, 1 week, 1 month), the core network 4 may update one or more of the UE-AMBR, the Session-AMBR, and the UE-Slice-MBR so that these values become smaller. Alternatively, if it is detected that the user of the radio terminal 3 has exhausted the data volume that can be used or consumed within a predetermined time period (e.g., 3 days, 1 week, 1 month), the core network 4 may update one or more of the UE-AMBR, the Session-AMBR, and the UE-Slice-MBR so that these values become smaller. On the other hand, if the data volume available to the user of the radio terminal 3 is restored for reasons such as entering a new predetermined time period, the core network 4 may update one or more of the UE-AMBR, the Session-AMBR, and the UE-Slice-MBR so that these values become larger.

In some implementations, depending on other causes such as congestion in the core network 4, the core network node 5 may provide the updated UE-AMBR, Session-AMBR, UE-Slice-MBR, or any combination thereof to the RAN node 1.

The UE-AMBR, the Session-AMBR, and the UE-Slice-MBR may be updated by a PCF in the core network 4. The PCF may provide the updated UE-AMBR and the updated UE-Slice-MBR to the AMF, and may provide the updated Session-AMBR to the SMF.

FIG. 17 shows a sequence diagram showing an example of the operation of the RAN nodes 1 and 2. In step 1701, the RAN node 1 (e.g., gNB or ng-eNB) sends one or more maximum bit rate parameters to the RAN node 2 via one or more control messages. The one or more maximum bit rate parameters may be an SN UE-AMBR, an SN Session-AMBR, an SN UE-Slice-MBR, or any combination thereof.

The SN UE-AMBR, SN Session-AMBR, and SN UE-Slice-MBR are determined by the RAN node 1 acting as the MN of DC for the radio terminal 3. Specifically, the RAN node (MN) 1 divides the UE-AMBR received from the core network node 5 into the UE-AMBR limit to be assigned to the MN (i.e., MN UE-AMBR) and the UE-AMBR limit to be assigned to the SN (i.e., SN UE-AMBR), and notifies the RAN node (SN) 2 of the SN UE-AMBR. Similarly, the RAN node (MN) 1 divides the Session-AMBR received from the core network node 5 into the Session-AMBR limit to be assigned to the MN (i.e., MN Session-AMBR) and the Session-AMBR limit to be assigned to the SN (i.e., SN Session-AMBR), and notifies the RAN node (SN) 2 of the SN Session-AMBR. Furthermore, the RAN node (MN) 1 divides the UE-Slice-MBR received from the core network node 5 into the UE-Slice-MBR limit to be assigned to the MN (i. e., MN UE-AMBR) and the UE-Slice-MBR limit to be assigned to the SN (i.e., SN UE-AMBR), and notifies the RAN node (SN) 2 of the SN UE-Slice-MBR.

Each of the control messages in Step 1701 may be an XnAP message. Specifically, each of the control messages may be an S-NODE ADDITION REQUEST message or an S-NODE MODIFICATION REQUEST message.

In step 1702, the RAN node 2 determines whether or not one or both of CA and DC are required for the radio terminal 3 based on one or more maximum bit rate parameters received from the RAN node 1.

In some implementations, if the UE-AMBR value received from the core network 4 is below a first threshold value, the RAN node 1 may determine or recognize that it will not perform (or initiate) CA and/or DC for the radio terminal 3. Similarly, if the UE-AMBR is below a first threshold value, the RAN node 1 may stop an ongoing CA and/or DC for the radio terminal 3. For example, the RAN node 1 may stop the use of part or all of the SCell(s) or SCG(s) that have been configured and activated for the radio terminal 3. On the other hand, if the UE-AMBR is above a second threshold value, the RAN node 1 may determine or recognize that it is allowed to perform (or initiate) CA and/or DC for the radio terminal 3. Similarly, if the UE-AMBR is above a second threshold value, the RAN node 1 may continue an ongoing CA and/or DC for the radio terminal 3. The second threshold value may be the same as or different from the first threshold value.

In some implementations, if the value of the Session-AMBR received from the core network 4 or the value of the UE-AMBR calculated using the Session-AMBR is below a first threshold value, the RAN node 1 may determine or recognize that it will not perform (or initiate) CA and/or DC for the radio terminal 3. Similarly, if the Session-AMBR or the UE-AMBR is below a first threshold value, the RAN node 1 may stop an ongoing CA and/or DC for the radio terminal 3. For example, the RAN node 1 may stop using part or all of the SCell(s) or SCG(s) that have been configured and activated for the QoS Flow(s) of the PDU Session associated with the Session-AMBR that is below the first threshold value. On the other hand, if the Session-AMBR or the UE-AMBR is above a second threshold value, the RAN node 1 may determine or recognize that it is allowed to perform (or initiate) CA and/or DC for the radio terminal 3. Similarly, if the Session-AMBR or the UE-AMBR is above a second threshold value, the RAN node 1 may continue an ongoing CA and/or DC for the radio terminal 3. The second threshold value may be the same as or different from the first threshold value.

In some implementations, if the UE-Slice-MBR value received from the core network 4 is below a first threshold value, the RAN node 1 may determine or recognize that it will not perform (or initiate) CA and/or DC for the radio terminal 3. Similarly, if the UE-Slice-MBR is below a first threshold value, the RAN node 1 may stop an ongoing CA and/or DC for the radio terminal 3. For example, the RAN node 1 may stop using part or all of the SCell(s) or SCG(s) that have been configured and activated for the QoS Flow(s) of the PDU Session(s) with active user plane in the network slice associated with the UE-Slice-MBR that is below the first threshold value. On the other hand, if the UE-Slice-MBR is above a second threshold value, the RAN node 1 may determine or recognize that it is allowed to perform (or initiate) CA and/or DC for the radio terminal 3. Similarly, if the UE-Slice-MBR is above a second threshold value, the RAN node 1 may continue an ongoing CA and/or DC for the radio terminal 3. The second threshold value may be the same as or different from the first threshold value.

In the same way as these operations of the RAN node 1, the RAN node 2 may use the SN UE-AMBR, SN Session-AMBR, or SN UE-Slice-MBR received from the RAN node 1 to determine the execution, initiation, suspension, or continuation of either or both CA and DC for the radio terminal 3.

CA can be initiated by adding or configuring one or more SCells, or by activating (or enabling) one or more SCells that have already been added or configured. The addition and release of an SCell(s) can be performed by the RAN node 1 or 2 sending an RRC (Connection) Reconfiguration message to the radio terminal 3. The activation of an SCell(s) can be performed by the RAN node 1 or 2 sending an SCell Activation/Deactivation MAC CE to the radio terminal 3.

CA can be stopped by releasing one or more SCells, or by deactivating (or disabling) one or more SCells. The release of SCells may be performed by the RAN node 1 or 2 sending an RRC (Connection) Reconfiguration message to the radio terminal 3. The deactivation of SCells may be performed by the RAN node 1 or 2 sending an SCell Activation/Deactivation MAC CE to the radio terminal 3. The RAN node 1 or 2 may provide the radio terminal 3 with an updated measurement configuration via an RRC (Connection) Reconfiguration message, so that the frequency of the released SCell(s) is excluded from the measurement objects of the radio terminal 3.

DC can be initiated by adding or configuring a new SN or SCG, or by activating (or enabling) an already added or configured SCG. The addition of an SN or SCG can be initiated by the MN (e.g., RAN node 1) by initiating an SN addition procedure. This SN Addition procedure includes the transmission of an S-NODE ADDITION REQUEST message from the MN (e.g., RAN node 1) to the SN (e.g., RAN node 2). This SN Addition procedure also includes the transmission of an MN RRC Reconfiguration message from the RAN node 1 to the radio terminal 3 containing an SN RRC configuration message generated by the RAN node 2. The activation of the SCG can be performed by sending an RRC message, MAC CE, or Downlink Control Information (DCI) from the MN (e.g., RAN node 1) or the SN (e.g., RAN node 2) to the radio terminal 3.

DC can be stopped by releasing the SN and SCG, or by deactivating (or inactivating) the SCG. The release of the SN and SCG can be performed by the MN (e.g., RAN node 1) or the SN (e.g., RAN node 2) initiating an SN release procedure. The SN release procedure initiated by the MN involves the transmission of an S-NODE RELEASE REQUEST message from the MN (e.g., RAN node 1) to the SN (e.g., RAN node 2). The SN release procedure initiated by the SN includes the transmission of an S-NODE RELEASE REQUIRED message from the SN (e.g., RAN node 2) to the MN (e.g., RAN node 1). In these SN release procedures, the MN (e.g., RAN node 1) may, if necessary, indicate to the radio terminal 3 in an MN RRC Reconfiguration message that the radio terminal 3 should release all SCG configurations. The MN (e.g., RAN node 1) may provide the radio terminal 3 with an updated measurement configuration via an RRC (Connection) Reconfiguration message, so that the released SCG frequency is excluded from the measurement objects of the radio terminal 3.

In the SN release procedure initiated by the MN, the MN (e.g., RAN node 1) may include in the S-NODE RELEASE REQUEST message a Cause information element indicating the cause of the SN release. Similarly, in the SN release procedure initiated by the SN, the SN (e.g., RAN node 2) may include in the S-NODE RELEASE REQUIRED message a Cause information element indicating the cause of the SN release. The Cause information element may be set to a value indicating, for example, that the radio terminal 3 is about to use up the data volume based on the contract, or that the radio terminal 3 has exhausted the data volume based on the contract. For example, this Cause information element may be set to “UE available data reaches maximum”.

The operation of the RAN node 1, as explained with reference to FIGS. 15 and 16, allows the RAN node 1 to determine whether or not CA or DC is required for the radio terminal 3, using one or more maximum bit rate parameters (e.g., UE-AMBR, Session-AMBR, UE-Slice-MBR, or any combination thereof) related to the radio terminal 3 provided by the core network 4. For example, the RAN node 1 may stop DC for part or all of the PDU Sessions of the radio terminal 3 in response to a decrease in the UE-AMBR, Session-AMBR, or UE-Slice-MBR of the radio terminal 3. This can, for example, help to reduce the wasteful consumption of RAN compute and radio resources.

The operation of the RAN node 2, as explained with reference to FIGS. 15 and 17, allows the RAN node 2 to determine whether or not CA or DC is required for the radio terminal 3, using one or more maximum bit rate parameters (e.g., SN UE-AMBR, SN Session-AMBR, SN UE-Slice-MBR, or any combination thereof) provided by the RAN node 1. For example, the RAN node 2 may stop DC for part or all of one or more PDU Sessions of the radio terminal 3 in response to a decrease in the UE-AMBR, Session-AMBR, or UE-Slice-MBR for the radio terminal 3. This can, for example, help to reduce unnecessary consumption of RAN compute and radio resources.

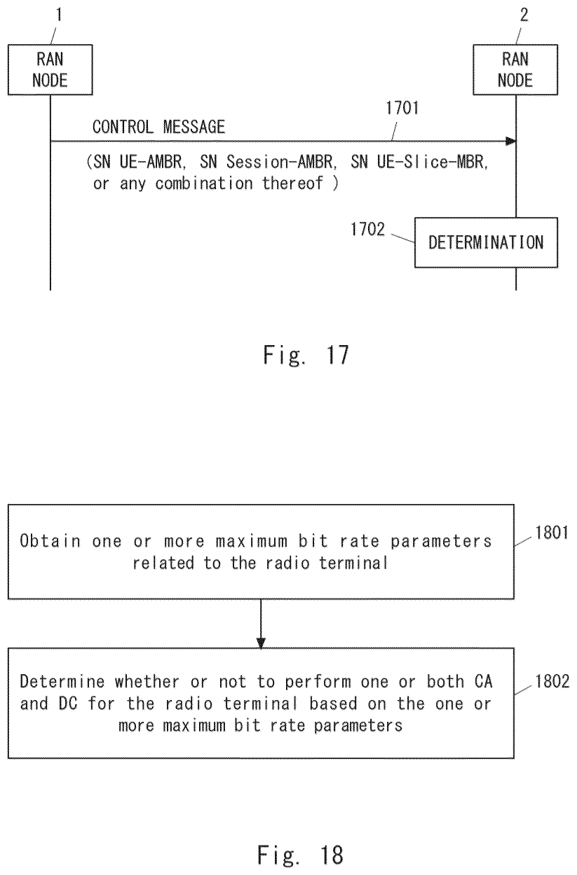

FIGS. 18 to 23 provide specific examples of the operation of the RAN nodes 1 and 2. The following describes examples of the operation of the RAN nodes 1 and 2 with reference to these figures.

FIG. 18 shows an example of the operation of the RAN node 1 or 2. Step 1801 is the same as step 1501 in FIG. 15.

In step 1802, the RAN node 1 or 2 determines whether or not to perform (or initiate) CA and/or DC for the radio terminal 3 based on the one or more maximum bit rate parameters. In other words, the RAN node 1 or 2 determines whether or not to perform (or initiate) CA and/or DC for the radio terminal 3 based on, depending on, using, or taking into account the one or more maximum bit rate parameters. Since the method of this determination has already been explained, a detailed explanation is omitted here.

FIG. 19 shows an example of the operation of the RAN node 1 or 2. Step 1901 is the same as step 1501 in FIG. 15.

In step 1902, the RAN node 1 or 2 determines the number of SCells to be configured or activated in CA for the radio terminal 3 based on the one or more maximum bit rate parameters. The RAN node 1 or 2 may increase the number of SCells to be configured or activated as the value of a maximum bit rate parameter increases. In other words, the RAN node 1 or 2 may decrease the number of SCells to be configured or activated as the value of a maximum bit rate parameter decreases.

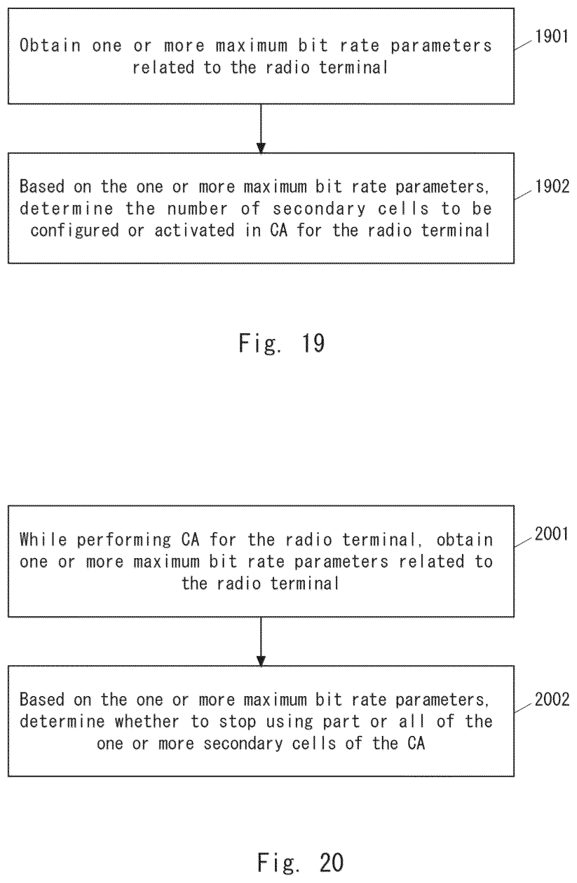

FIG. 20 shows an example of the operation of the RAN node 1 or 2. Step 2001 is the same as step 1501 in FIG. 15. However, in step 2001, while the RAN node 1 or 2 is performing CA for the radio terminal 3, the RAN node 1 or 2 obtains one or more maximum bit rate parameters related to the radio terminal 3.

In step 2002, the RAN node 1 or 2 determines whether to stop using part or all of the one or more SCells of the ongoing CA for the radio terminal 3, based on one or more maximum bit rate parameters. The method of making this decision can be the same as one of the methods already explained. A plurality of threshold values may be used to make this determination. More specifically, if the value of a maximum bit rate parameter is below a first threshold value, the RAN node 1 or 2 may release (or deactivate) some of the SCells that have been configured (or activated) in the CA. If the value of this maximum bit rate parameter is below a second threshold value that is less than the first threshold value, the RAN node 1 or 2 may release (or deactivate) all the SCells that have been configured (or activated) in the CA.

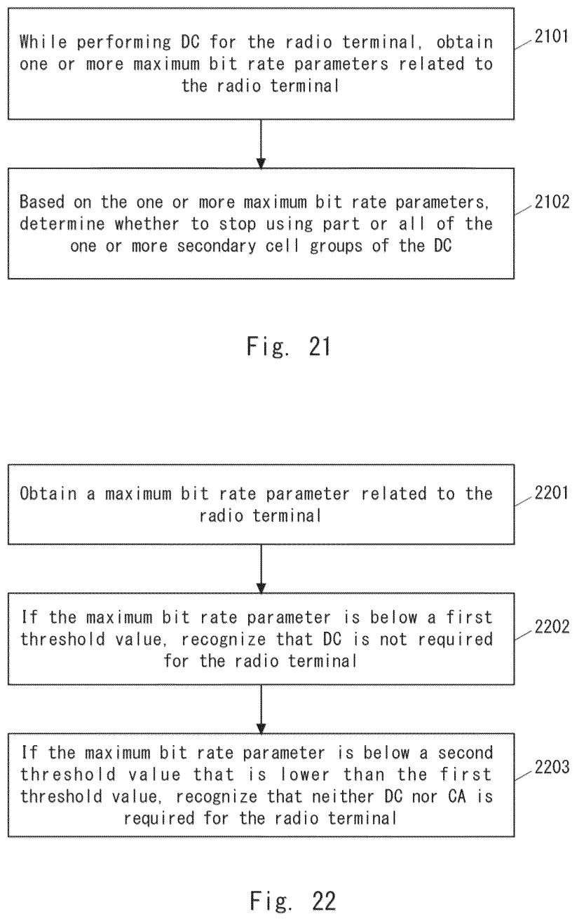

FIG. 21 shows an example of the operation of the RAN node 1 or 2. Step 2101 is the same as step 1501 in FIG. 15. However, in step 2101, while the RAN node 1 and 2 are performing DC for the radio terminal 3, the RAN node 1 or 2 obtains one or more maximum bit rate parameters related to the radio terminal 3.

In step 2102, the RAN node 1 or 2 determines whether to stop using part or all of the one or more SCGs of the ongoing DC for the radio terminal 3, based on one or more maximum bit rate parameters. The method of making this decision can be the same as one of the methods already explained. A plurality of threshold values may be used to make this determination. More specifically, if the value of a maximum bit rate parameter is below a first threshold value, the RAN node 1 or 2 may release (or deactivate) some of the SCGs that have been configured (or activated) in the DC. If the value of this maximum bit rate parameter is below a second threshold value that is less than the first threshold value, the RAN node 1 or 2 may release (or deactivate) all the SCGs that have been configured (or activated) in the DC.

FIG. 22 shows an example of the operation of the RAN node 1. Step 2201 is the same as step 1501 in FIG. 15.

In step 2202, if the value of a maximum bit rate parameter is less than a first threshold value, the RAN node 1 determines or recognizes that DC is not required for the radio terminal 3. In step 2203, if the value of the maximum bit rate parameter is less than a second threshold value, which is less than the first threshold value, the RAN node 1 determines or recognizes that neither DC nor CA is required for the radio terminal 3. The sequence of steps 2202 and 2203 is not restricted. Steps 2202 and 2203 may be performed substantially simultaneously, or step 2203 may be performed before step 2202.

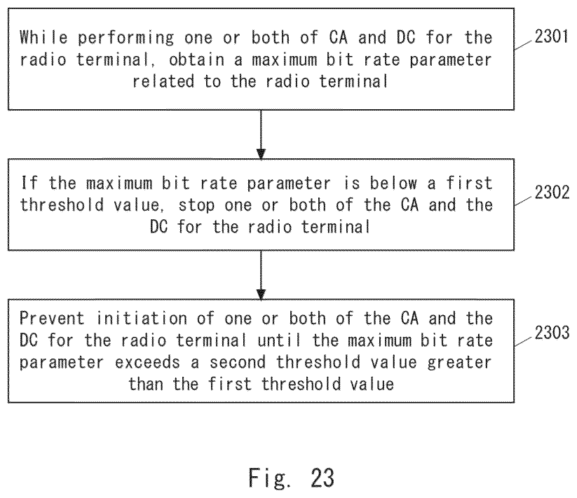

FIG. 23 shows an example of the operation of the RAN node 1. Step 2301 is the same as step 1501 in FIG. 15. However, in step 2301, while the RAN node 1 is performing one or both of CA and DC for the radio terminal 3, the RAN node 1 obtains a maximum bit rate parameter.

In step 2302, if the value of the maximum bit rate parameter is below a first threshold value, the RAN node 1 stops one or both of the CA and the DC for the radio terminal 3.

In step 2303, the RAN node 1 prevents initiation of one or both of the CA and the DC for the radio terminal 3 until the value of the maximum bit rate parameter exceeds a second threshold value that is greater than the first threshold value. In other words, the RAN node 2 stops the CA and/or the DC for the radio terminal 3 until it obtains an updated value of the maximum bit rate parameter that exceeds the second threshold value.

### Fourth Example Embodiment

This example embodiment provides improvements in the operation of a RAN node. An example configuration of a radio communication system according to this example embodiment may be the same as the example shown in FIG. 1.

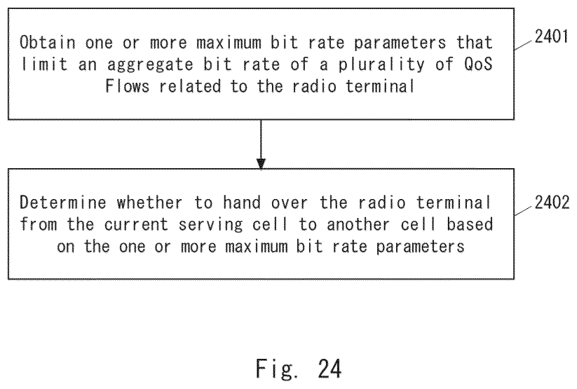

FIG. 24 shows an example of the operation of the RAN node 1. In step 2401, the RAN node 1 obtains one or more maximum bit rate parameters that limit an aggregate bit rate of a plurality of QoS Flows related to the radio terminal 3. Specific examples of the one or more maximum bit rate parameters may be the same as those described in the third example embodiment. Specifically, the one or more maximum bit rate parameters may be a UE-AMBR, a Session-AMBR, or a UE-Slice-MBR, or any combination thereof. The RAN node 1 may receive the one or more maximum bit rate parameters from the core network 4 via one or more control messages.

In step 2402, the RAN node 1 determines whether or not to hand over the radio terminal 3 from the current serving cell to another cell based on the one or more maximum bit rate parameters. For example, if the value of a maximum bit rate parameter is below a first threshold value, the RAN node 1 may determine to hand over the radio terminal 3 from the current serving cell supporting high-speed communication to another cell. On the other hand, if the value of the maximum bit rate parameter exceeds a second threshold value, the RAN node 1 may decide to hand over the radio terminal 3 from the current serving cell to another cell supporting high-speed communication. The second threshold value may be the same as or different from the first threshold value. For example, cells supporting high-speed communication may be cells operating in a mmWave (FR2) band, while other cells may be sub-6 GHZ (FR1) band. Alternatively, cells supporting high-speed communication may be 5G New Radio (NR) cells, while other cells may be LTE cells.

The operation of the RAN node 1, as explained with reference to FIG. 24, allows the RAN node 1 to determine whether a handover of the radio terminal 3 is required or not, using one or more maximum bit rate parameters (e.g., UE-AMBR, Session-AMBR, UE-Slice-MBR, or any combination thereof) related to the radio terminal 3 provided by the core network 4.

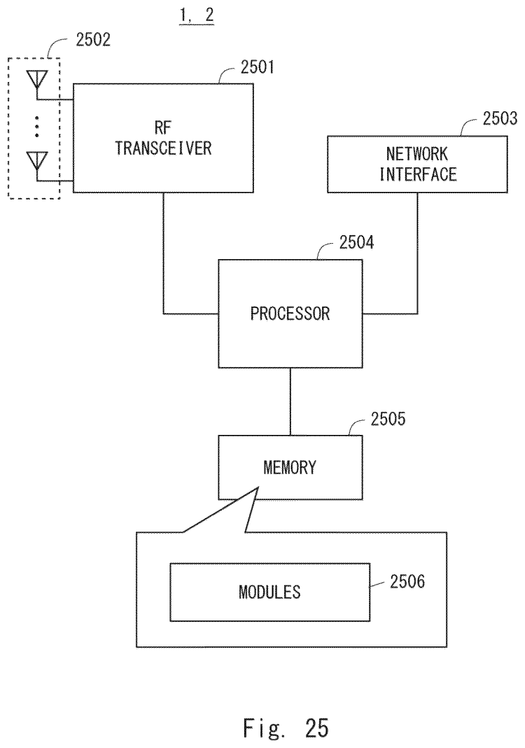

Examples of configurations of the RAN nodes 1 and 2, the radio terminal 3, and the core network node 5 according to the plurality of example embodiments described above are provided below. FIG. 25 is a block diagram showing an example of the configuration of the RAN node 1. The configuration of the other RAN node 2 may be the same as the configuration shown in FIG. 25. Referring to FIG. 25, the RAN node 2 includes a Radio Frequency transceiver 2501, a network interface 2503, a processor 2504, and a memory 2505. The RF transceiver 2501 performs analog RF signal processing to communicate with UEs including the UE 3. The RF transceiver 2501 may include a plurality of transceivers. The RF transceiver 2501 is coupled to an antenna array 2502 and the processor 2504. The RF transceiver 2501 receives modulated symbol data from the processor 2504, generates a transmission RF signal, and supplies the transmission RF signal to the antenna array 2502. The RF transceiver 2501 generates a baseband reception signal based on a reception RF signal received by the antenna array 2502 and supplies the baseband reception signal to the processor 2504. The RF transceiver 2501 may include an analog beamformer circuit for beamforming. The analog beamformer circuit includes, for example, a plurality of phase shifters and a plurality of power amplifiers.

The network interface 2503 is used to communicate with network nodes (e.g., other RAN nodes and nodes in the core network 4). For example, the network interface 2503 may include a network interface card (NIC) that complies with the IEEE 802.3 series.

The processor 2504 performs digital baseband signal processing (data plane processing) and control plane processing for wireless communication. The processor 2504 may include a plurality of processors. For example, the processor 2504 may include a modem processor (e.g., a Digital Signal Processor (DSP)) that performs digital baseband signal processing and a protocol stack processor (e.g., a Central Processing Unit (CPU) or a Micro Processing Unit (MPU)) that performs control plane processing.

For example, the digital baseband signal processing performed by the processor 2504 may include signal processing for the Service Data Adaptation Protocol (SDAP), Packet Data Convergence Protocol (PDCP), Radio Link Control (RLC), Medium Access Control (MAC), and Physical (PHY) layers. The control plane processing by the processor 2504 may also include processing of Non-Access Stratum (NAS) messages, RRC messages, MAC Control Elements (CEs), and Downlink Control Information (DCI).

The processor 2504 may include a digital beamformer module for beamforming. The digital beamformer module may include a multiple input multiple output (MIMO) encoder and precoder.

The memory 2505 is composed of a combination of volatile and non-volatile memory. The volatile memory is, for example, Static Random Access Memory (SRAM), Dynamic RAM (DRAM), or a combination thereof. The non-volatile memory is Mask Read Only Memory (MROM), Electrically Erasable Programmable ROM (EEPROM), flash memory, hard disk drive, or any combination thereof. The memory 2505 may include storage that is remote from the processor 2504. In this case, the processor 2504 may access the memory 2505 through a network interface 2503 or an I/O interface not shown.

The memory 2505 may store one or more software modules (or computer programs) 2506 containing a set of instructions and data for processing by the RAN node 1 described in the example embodiments described above. In some implementations, the processor 2504 may be configured to read and execute the software module 2506 from the memory 2505, thereby performing the processing of the RAN node 1 described in the example embodiments described above.

The control plane processing and operations performed by the RAN node 1 described in the above example embodiment can be performed by the processor 2504 and the memory 2505 containing the software module 2506.

If the RAN Node 1 is a CU (e.g., eNB-CU or gNB-CU) or a CU-CP, the RAN Node 1 does not need to include the RF transceiver 2501 (and the antenna array 2502).

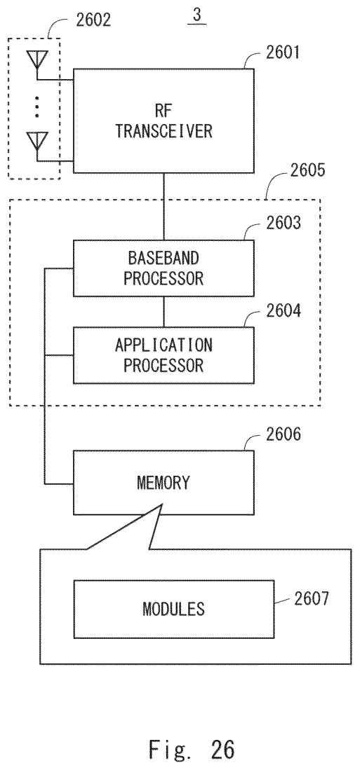

FIG. 26 shows a block diagram of an example configuration of the radio terminal 3. The Radio Frequency (RF) transceiver 2601 performs analog RF signal processing to communicate with the RAN nodes 1 and 2. The RF transceiver 2601 may include a plurality of transceivers. The analog RF signal processing performed by the RF transceiver 2601 includes frequency up-conversion, frequency down-conversion, and amplification. The RF transceiver 2601 is coupled with an antenna array 2602 and a baseband processor 2603. The RF transceiver 2601 receives modulated symbol data (or OFDM symbol data) from the baseband processor 2603, generates a transmission RF signal, and supplies the transmission RF signal to the antenna array 2602. The RF transceiver 2601 also generates a baseband received signal based on a received RF signal received by the antenna array 2602, and supplies the baseband received signal to the baseband processor 2603. The RF transceiver 2601 may include an analog beamformer circuit for beamforming. The analog beamformer circuit includes, for example, multiple phase shifters and multiple power amplifiers.

The baseband processor 2603 performs digital baseband signal processing (data-plane processing) and control-plane processing for wireless communication. The digital baseband signal processing includes (a) data compression/decompression, (b) data segmentation/concatenation, (c) transmission format (transmission frame) composition/decomposition, (d) channel encoding/decoding, (e) modulation (i.e., symbol mapping)/demodulation, and (f) generation of OFDM symbol data (baseband OFDM signal) using Inverse Fast Fourier Transform (IFFT) and so on. On the other hand, the control-plane processing includes communication management of layer 1 (e.g., transmission power control), layer 2 (e.g., radio resource management, and hybrid automatic repeat request (HARQ) processing), and layer 3 (e.g., signaling related to attach, mobility, and call management).

For example, the digital baseband signal processing performed by the baseband processor 2603 may include signal processing for the SDAP, PDCP, RLC, MAC, and PHY layers. The control plane processing by the baseband processor 2603 may include processing of Non-Access Stratum (NAS) protocols, RRC protocols, MAC CEs, and DCIs.

The baseband processor 2603 may perform MIMO encoding and precoding for beamforming.

The baseband processor 2603 may include a modem processor (e.g., DSP) that performs digital baseband signal processing and a protocol stack processor (e.g., CPU or MPU) that performs control plane processing. In this case, the protocol stack processor that performs control plane processing may be integrated with an application processor 2604 described later.

The application processor 2604 is also referred to as a CPU, MPU, microprocessor, or processor core. The application processor 2604 may include a plurality of processors (a plurality of processor cores). The application processor 2604 executes system software programs (operating system (OS)) and various application programs (e.g., voice call application, web browser, mailer, camera control application, music player application) read from a memory 2606 or other memory not shown, thereby realizing various functions of the radio terminal 3.

In some implementations, as shown by the dashed line (2605) in FIG. 26, the baseband processor 2603 and the application processor 2604 may be integrated on a single chip. In other words, the baseband processor 2603 and the application processor 2604 may be implemented as a single System on Chip (SoC) device 2605. The SoC device may also be referred to as a system large-scale integration (LSI) or chipset.

The memory 2606 is a volatile memory, a non-volatile memory, or a combination thereof. The memory 2606 may include a plurality of physically independent memory devices. The volatile memory is, for example, SRAM, DRAM, or a combination thereof. The non-volatile memory is, for example, MROM, EEPROM, flash memory, or a hard disk drive, or any combination thereof. For example, the memory 2606 may include an external memory device that is accessible by the baseband processor 2603, the application processor 2604, and the SoC 2605. The memory 2606 may include an internal memory device that is integrated into the baseband processor 2603, the application processor 2604, or the SoC 2605. In addition, the memory 2606 may include memory within a Universal Integrated Circuit Card (UICC).

The memory 2606 may store one or more software modules (or computer programs) 2607 that include a set of instructions and data for performing the processing by the radio terminal 3 described in the above example embodiments. In some implementations, the baseband processor 2603 or the application processor 2604 may be configured to read and execute the software modules 2607 from the memory 2606, thereby performing the processing of the radio terminal 3 as described in the example embodiments with reference to the drawings.

The control plane processing and operations performed by the radio terminal 3 described in the above example embodiment can be implemented by elements other than the RF transceiver 2601 and the antenna array 2602, namely at least one of the baseband processor 2603 and the application processor 2604, and the memory 2606 that stores the software modules 2607.

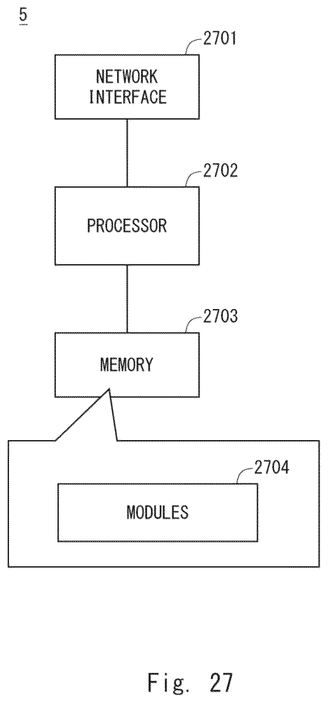

FIG. 27 shows an example of the configuration of the core network node 5. Referring to FIG. 27, the core network node 5 includes a network interface 2701, a processor 2702, and a memory 2703.

The network interface 2701 is used, for example, to communicate with other network functions (NFs) or nodes. For example, the network interface 2701 may include a network interface card (NIC) compliant with the IEEE 802.3 series.

The processor 2702 may be, for example, a microprocessor, an MPU, or a CPU. The processor 2702 may include a plurality of processors.

The memory 2703 is composed of a volatile memory and a non-volatile memory. The memory 2703 may include a plurality of physically independent memory devices. The volatile memory is, for example, SRAM, DRAM, or a combination thereof. The non-volatile memory is, for example, MROM, EEPROM, flash memory, a hard disk drive, or any combination thereof. The memory 2703 may include storage that is remote from the processor 2702. In this case, the processor 2702 may access the memory 2703 through the network interface 2701 or an I/O interface.

The memory 2703 may store one or more software modules (or computer programs) 2704 that include a set of instructions and data for performing the processing by the core network node 5 described in the above example embodiments. In some implementations, the processor 2702 may be configured to read and execute the software modules 2704 from the memory 2703, thereby performing the processing of the core network node 5 as described in the above example embodiments.

As described using FIGS. 25, 26, and 27, each of the processors in the RAN node 1 and 2, the radio terminal 3, and the core network node 5 according to the example embodiments described above can execute one or more programs, containing a set of instructions, to cause a computer to perform an algorithm described with reference to the drawings. Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustical, or other form of propagated signals.

The example embodiments described above are merely examples of applications of the technical ideas of the inventors. These technical ideas are not limited to the above-described example embodiments, and various modifications may be made thereto.

For example, the whole or part of the example embodiments disclosed above can be described as, but not limited to, the following supplementary notes.

### (Supplementary Note 1)

A radio access network node comprising:
at least one memory; and
at least one processor coupled to the at least one memory and configured to receive from a core network a first control message containing a first information element relating to a radio terminal, wherein
the first information element indicates at least one of:
   an amount of data available to the radio terminal; or
   whether or not one or both of carrier aggregation and dual connectivity are required or allowed with respect to the radio terminal.

### (Supplementary Note 2)

The radio access network node according to Supplementary Note 1, wherein the first information element at least indicates whether or not one or both of carrier aggregation and dual connectivity are required or allowed with respect to the radio terminal.

### (Supplementary Note 3)

The radio access network node according to Supplementary Note 1, wherein
the first information element indicates at least the amount of data available to the radio terminal, and
the amount of data is a remaining amount of data available to a user of the radio terminal until end of a current month.

### (Supplementary Note 4)

The radio access network node according to any one of Supplementary Notes 1 to 3, wherein the at least one processor is configured to determine, based on the first information element, whether to perform one or both of carrier aggregation and dual connectivity for the radio terminal.

### (Supplementary Note 5)

The radio access network node according to any one of Supplementary Notes 1 to 3, wherein the at least one processor is configured to determine, based on the first information element, whether to stop using part or all of one or more secondary cells of ongoing carrier aggregation for the radio terminal.

### (Supplementary Note 6)

The radio access network node according to any one of Supplementary Notes 1 to 3, wherein the at least one processor is configured to determine, based on the first information element, whether to stop using part or all of one or more secondary cell groups of ongoing dual connectivity for the radio terminal.

### (Supplementary Note 7)

The radio access network node according to any one of Supplementary Notes 1 to 3, wherein the at least one processor is configured to send a second control message containing a second information element derived based on the first information element to a secondary node of dual connectivity for the radio terminal.

### (Supplementary Note 8)

The radio access network node according to Supplementary Note 7, wherein the second information element is used by the secondary node to determine whether to stop using part or all of one or more secondary cells of ongoing carrier aggregation in a secondary cell group for the radio terminal.

### (Supplementary Note 9)

The radio access network node according to Supplementary Note 7, wherein the second information element is used by the secondary node to determine whether to stop using part or all of one or more secondary cell groups of ongoing dual connectivity for the radio terminal.

### (Supplementary Note 10)

The radio access network node according to any one of Supplementary Notes 1 to 3, wherein the at least one processor is configured to determine whether to hand over the radio terminal from a current serving cell to another cell based on the first information element.

### (Supplementary Note 11)

The radio access network node according to Supplementary Note 1 or 3, wherein
the at least one processor is configured to recognize that dual connectivity is not required for the radio terminal if the amount of data is below a first threshold value, and
the at least one processor is configured to recognize that neither dual connectivity nor carrier aggregation is required for the radio terminal if the amount of data is below a second threshold value that is less than the first threshold value.

### (Supplementary Note 12)

The radio access network node according to Supplementary Note 1, 3, or 11, wherein
the at least one processor is configured to stop one or both of carrier aggregation and dual connectivity for the radio terminal if the amount of data is below a third threshold value, and
the at least one processor is configured to prevent initiation of one or both of carrier aggregation and dual connectivity for the radio terminal until the amount of data exceeds a fourth value greater than the third threshold value.

### (Supplementary Note 13)

The radio access network node according to any one of Supplementary Notes 1 to 12, wherein
the first control message is an NG Application Protocol (NGAP) message, and
the first control message is an INITIAL CONTEXT SETUP REQUEST message, a UE CONTEXT MODIFICATION REQUEST message, or a PDU SESSION RESOURCE SETUP REQUEST message.

### (Supplementary Note 14)

The radio access network node according to any one of Supplementary Notes 7 to 9, wherein
the second control message is an Xn Application Protocol (XnAP) message, and
the second control message is an S-NODE ADDITION REQUEST message or an S-NODE MODIFICATION REQUEST message.

### (Supplementary Note 15)

A method performed by a radio access network node, the method comprising:
receiving from a core network a first control message containing a first information element relating to a radio terminal, wherein
the first information element indicates at least one of:
   an amount of data available to the radio terminal; or
   whether or not one or both of carrier aggregation and dual connectivity are required or allowed with respect to the radio terminal.

### (Supplementary Note 16)

A program for causing a computer to perform a method for a radio access network node, the method comprising:
receiving from a core network a first control message containing a first information element relating to a radio terminal, wherein
the first information element indicates at least one of:
   an amount of data available to the radio terminal; or
   whether or not one or both of carrier aggregation and dual connectivity are required or allowed with respect to the radio terminal.

### (Supplementary Note 17)

A core network node comprising:
at least one memory; and
at least one processor coupled to the at least one memory and configured to send to a radio access network node a first control message containing a first information element relating to a radio terminal, wherein
the first information element indicates at least one of:
   an amount of data available to the radio terminal; or
   whether or not one or both of carrier aggregation and dual connectivity are required or allowed with respect to the radio terminal.

### (Supplementary Note 18)

The core network node according to Supplementary Note 17, wherein the first information element at least indicates whether or not one or both of carrier aggregation and dual connectivity are required or allowed with respect to the radio terminal.

### (Supplementary Note 19)

The core network node according to Supplementary Note 17, wherein
the first information element indicates at least the amount of data available to the radio terminal, and
the amount of data is a remaining amount of data available to a user of the radio terminal until end of a current month.

### (Supplementary Note 20)

The core network node according to any one of Supplementary Notes 17 to 19, wherein the first information element is used by the radio access network node to determine whether to perform one or both of carrier aggregation and dual connectivity for the radio terminal.

### (Supplementary Note 21)

The core network node according to any one of Supplementary Notes 17 to 19, wherein the first information element is used by the radio access network node to determine whether to stop using part or all of one or more secondary cells of ongoing carrier aggregation for the radio terminal.

### (Supplementary Note 22)

The core network node according to any one of Supplementary Notes 17 to 19, wherein the first information element is used by the radio access network node to determine whether to stop using part or all of one or more secondary cell groups of ongoing dual connectivity for the radio terminal.

### (Supplementary Note 23)

The core network node according to any one of Supplementary Notes 17 to 19, wherein the first information element is used by the radio access network node to determine whether to hand over the radio terminal from a current serving cell to another cell.

### (Supplementary Note 24)

The core network node according to any one of Supplementary Notes 17 to 23, wherein
the at least one processor is configured to receive from the radio terminal a second control message containing an information element indicating whether one or both of carrier aggregation and dual connectivity is required, and
the at least one processor is configured to determine the first information element based on the information element received from the radio terminal.

### (Supplementary Note 25)

The core network node according to any one of Supplementary Notes 17 to 24, wherein
the first control message is an NG Application Protocol (NGAP) message, and
the first control message is an INITIAL CONTEXT SETUP REQUEST message, a UE CONTEXT MODIFICATION REQUEST message, or a PDU SESSION RESOURCE SETUP REQUEST message.

### (Supplementary Note 26)

A method performed by a core network node, the method comprising:
sending to a radio access network node a first control message containing a first information element relating to a radio terminal, wherein
the first information element indicates at least one of:
   an amount of data available to the radio terminal; or
   whether or not one or both of carrier aggregation and dual connectivity are required or allowed with respect to the radio terminal.

### (Supplementary Note 27)

A program for causing a computer to perform a method for a core network node, the method comprising:
sending to a radio access network node a first control message containing a first information element relating to a radio terminal, wherein
the first information element indicates at least one of:
   an amount of data available to the radio terminal; or
   whether or not one or both of carrier aggregation and dual connectivity are required or allowed with respect to the radio terminal.

### (Supplementary Note 28)

A radio terminal comprising:
at least one memory; and
at least one processor coupled to the at least one memory and configured to send to a core network a control message containing an information element indicating whether or not one or both of carrier aggregation and dual connectivity are required.

### (Supplementary Note 29)

The radio terminal according to Supplementary Note 28, wherein the information element is used by the core network to inform a radio access network node whether or not one or both of carrier aggregation and dual connectivity are required or allowed with respect to the radio terminal.

### (Supplementary Note 30)

The radio terminal according to Supplementary Note 28 or 29, wherein
the control message is a Non-Access-Stratum (NAS) message, and
the control message is a REGISTRATION REQUEST message, a SERVICE REQUEST message, a UL NAS TRANSPORT message, a PDU SESSION ESTABLISHMENT REQUEST message, or a PDU SESSION MODIFICATION REQUEST message.

### (Supplementary Note 31)

A method performed by a radio terminal, the method comprising:
sending to a core network a control message containing an information element indicating whether or not one or both of carrier aggregation and dual connectivity are required.

### (Supplementary Note 32)

A method for a computer to perform a method for a radio terminal, the method comprising:
sending to a core network a control message containing an information element indicating whether or not one or both of carrier aggregation and dual connectivity are required.

### (Supplementary Note 33)

A radio access network node comprising:
a least one memory; and
at least one processor coupled to the at least one memory and configured to:
   obtain one or more maximum bit rate parameters that limit an aggregate bit rate of a plurality of Quality of Service (QOS) flows with respect to a radio terminal; and
   perform a determination of whether or not one or both of carrier aggregation and dual connectivity are required with respect to the radio terminal based on the one or more maximum bit rate parameters.

### (Supplementary Note 34)

The radio access network node according to Supplementary Note 33, wherein the determination comprises determining whether to perform dual connectivity for the radio terminal based on the one or more maximum bit rate parameters.

### (Supplementary Note 35)

The radio access network node according to Supplementary Note 33, wherein the determination comprises determining whether to perform carrier aggregation for the radio terminal based on the one or more maximum bit rate parameters.

### (Supplementary Note 36)

The radio access network node according to Supplementary Note 33, wherein the determination comprises determining a number of secondary cells to be configured or activated in carrier aggregation for the radio terminal based on the one or more maximum bit rate parameters.

### (Supplementary Note 37)

The radio access network node according to Supplementary Note 33, wherein the determination comprises determining whether to stop using part or all of one or more secondary cells of ongoing carrier aggregation for the radio terminal based on the one or more maximum bit rate parameters.

### (Supplementary Note 38)

The radio access network node according to Supplementary Note 33, wherein the determination comprises determining whether to stop using part or all of one or more secondary cell groups of ongoing dual connectivity for the radio terminal based on the one or more maximum bit rate parameters.

### (Supplementary Note 39)

The radio access network node according to Supplementary Note 33, wherein
the at least one processor is configured to recognize that dual connectivity is not required for the radio terminal if one of the one or more maximum bit rate parameters is below a first threshold value, and
the at least one processor is configured to recognize that neither dual connectivity nor carrier aggregation is required for the radio terminal if the one maximum bit rate parameter is below a second threshold value that is less than the first threshold value.

### (Supplementary Note 40)

The radio access network node according to Supplementary Note 33, wherein
the at least one processor is configured to stop one or both of carrier aggregation and dual connectivity for the radio terminal if one of the one or more maximum bit rate parameters is below a third threshold value, and
the at least one processor is configured to prevent initiation of one or both of carrier aggregation and dual connectivity for the radio terminal until the one maximum bit rate parameter exceeds a fourth value greater than the third threshold value.

### (Supplementary Note 41)

The radio access network node according to any one of Supplementary Notes 33 to 40, wherein the one or more maximum bit rate parameters comprise an Aggregate Maximum Bit Rate per radio terminal, an Aggregate Maximum Bit Rate per PDU Session of the radio terminal, or a Maximum Bit Rate per network slice of the radio terminal, or any combination thereof.

### (Supplementary Note 42)

The radio access network node according to any one of Supplementary Notes 33 to 40, wherein the one or more maximum bit rate parameters comprise a per User Equipment Aggregate Maximum Bit Rate (UE-AMBR), a per Session Aggregate Maximum Bit Rate (Session-AMBR), or a per UE per Slice-Maximum Bit Rate (UE-Slice-MBR), or any combination thereof.

### (Supplementary Note 43)

The radio access network node according to any one of Supplementary Notes 33 to 42, wherein the obtaining of the one or more maximum bit rate parameters comprises receiving the one or more maximum bit rate parameters from a core network via one or more control messages.

### (Supplementary Note 44)

The radio access network node according to Supplementary Note 43, wherein
each of the one or more control messages is an NG Application Protocol (NGAP) message, and
each of the one or more control messages is an INITIAL CONTEXT SETUP REQUEST message, a UE CONTEXT MODIFICATION REQUEST message, a PDU SESSION RESOURCE SETUP REQUEST message, or a PDU SESSION RESOURCE MODIFY REQUEST message.

### (Supplementary Note 45)

The radio access network node according to any one of Supplementary Notes 33, 35-38, and 40, wherein the obtaining of the one or more maximum bit rate parameters comprises receiving the one or more maximum bit rate parameters from a master node of dual connectivity via one or more control messages.

### (Supplementary Note 46)

The radio access network node according to Supplementary Note 45, wherein
the control message is an Xn Application Protocol (XnAP) message, and
the control message is an S-NODE ADDITION REQUEST message or an S-NODE MODIFICATION REQUEST message.

### (Supplementary Note 47)

A method performed by a radio access network node, the method comprising:
obtaining one or more maximum bit rate parameters that limit an aggregate bit rate of a plurality of Quality of Service (QOS) flows with respect to a radio terminal; and
performing a determination of whether or not one or both of carrier aggregation and dual connectivity are required with respect to the radio terminal based on the one or more maximum bit rate parameters.

### (Supplementary Note 48)

A program for causing a computer to perform a method for a radio access network node, the method comprising:
obtaining one or more maximum bit rate parameters that limit an aggregate bit rate of a plurality of Quality of Service (QOS) flows with respect to a radio terminal; and
performing a determination of whether or not one or both of carrier aggregation and dual connectivity are required with respect to the radio terminal based on the one or more maximum bit rate parameters.

### (Supplementary Note 49)

A radio access network node comprising:
at least one memory; and
at least one processor coupled to the at least one memory and configured to:
   obtain one or more maximum bit rate parameters that limit an aggregate bit rate of a plurality of Quality of Service (QOS) flows with respect to a radio terminal; and
   determine whether to hand over the radio terminal from a current serving cell to another cell based on the one or more maximum bit rate parameters.

### (Supplementary Note 50)

The radio access network node according to Supplementary Note 49, wherein the one or more maximum bit rate parameters comprise an Aggregate Maximum Bit Rate per radio terminal, an Aggregate Maximum Bit Rate per PDU Session of the radio terminal, or a Maximum Bit Rate per network slice of the radio terminal, or any combination thereof.

### (Supplementary Note 51)

The radio access network node according to Supplementary Note 49 or 50, wherein the obtaining of the one or more maximum bit rate parameters comprises receiving the one or more maximum bit rate parameters from a core network via one or more control messages.

### (Supplementary Note 52)

A method performed by a radio access network node, the method comprising:
obtaining one or more maximum bit rate parameters that limit an aggregate bit rate of a plurality of Quality of Service (Qos) flows with respect to a radio terminal; and
determining whether to hand over the radio terminal from a current serving cell to another cell based on the one or more maximum bit rate parameters.

### (Supplementary Note 53)

A program for causing a computer to perform a method for a radio access network node, the method comprising:
obtaining one or more maximum bit rate parameters that limit an aggregate bit rate of a plurality of Quality of Service (QOS) flows with respect to a radio terminal; and
determining whether to hand over the radio terminal from a current serving cell to another cell based on the one or more maximum bit rate parameters.

This application is based upon and claims the benefit of priority from Japanese Patent Application No. 2022-090224, filed on Jun. 2, 2022, the disclosure of which is incorporated herein in its entirety by reference.

### REFERENCE SIGNS LIST

1 RAN node
2 RAN node
3 Radio terminal
4 Core network
5 Core network node
2504 Processor
2505 Memory
2506 Modules
2603 Baseband processor
2604 Application processor
2606 Memory
2607 Modules
2702 Processor
2703 Memory
2704 Modules

What is claimed is:

1. A radio access network node comprising:
at least one memory; and
at least one processor coupled to the at least one memory and configured to receive from a core network a first control message containing a first information element relating to a radio terminal, wherein
the first information element indicates at least one of:
an amount of data available to the radio terminal; or
whether or not one or both of carrier aggregation and dual connectivity are required or allowed with respect to the radio terminal.

2. The radio access network node according to claim 1, wherein the first information element at least indicates whether or not one or both of carrier aggregation and dual connectivity are required or allowed with respect to the radio terminal.

3. The radio access network node according to claim 1, wherein
the first information element indicates at least the amount of data available to the radio terminal, and
the amount of data is a remaining amount of data available to a user of the radio terminal until end of a current month.

4. The radio access network node according to claim 1, wherein the at least one processor is configured to determine, based on the first information element, whether to perform one or both of carrier aggregation and dual connectivity for the radio terminal.

5. The radio access network node according to claim 1, wherein the at least one processor is configured to determine, based on the first information element, whether to stop using part or all of one or more secondary cells of ongoing carrier aggregation for the radio terminal.

6. The radio access network node according to claim 1, wherein the at least one processor is configured to determine, based on the first information element, whether to stop using part or all of one or more secondary cell groups of ongoing dual connectivity for the radio terminal.

7. The radio access network node according to claim 1, wherein the at least one processor is configured to send a second control message containing a second information element derived based on the first information element to a secondary node of dual connectivity for the radio terminal.

8. The radio access network node according to claim 7, wherein the second information element is used by the secondary node to determine whether to stop using part or all of one or more secondary cells of ongoing carrier aggregation in a secondary cell group for the radio terminal.

9. The radio access network node according to claim 7, wherein the second information element is used by the secondary node to determine whether to stop using part or all of one or more secondary cell groups of ongoing dual connectivity for the radio terminal.

10. The radio access network node according to claim 1, wherein the at least one processor is configured to determine whether to hand over the radio terminal from a current serving cell to another cell based on the first information element.

11. The radio access network node according to claim 1, wherein
the at least one processor is configured to recognize that dual connectivity is not required for the radio terminal if the amount of data is below a first threshold value, and
the at least one processor is configured to recognize that neither dual connectivity nor carrier aggregation is required for the radio terminal if the amount of data is below a second threshold value that is less than the first threshold value.

12. The radio access network node according to claim 1, wherein
the at least one processor is configured to stop one or both of carrier aggregation and dual connectivity for the radio terminal if the amount of data is below a third threshold value, and
the at least one processor is configured to prevent initiation of one or both of carrier aggregation and dual connectivity for the radio terminal until the amount of data exceeds a fourth value greater than the third threshold value.

13. The radio access network node according to claim 1, wherein
the first control message is an NG Application Protocol (NGAP) message, and
the first control message is an INITIAL CONTEXT SETUP REQUEST message, a UE CONTEXT MODIFICATION REQUEST message, or a PDU SESSION RESOURCE SETUP REQUEST message.

14. The radio access network node according to claim 7 wherein
the second control message is an Xn Application Protocol (XnAP) message, and
the second control message is an S-NODE ADDITION REQUEST message or an S-NODE MODIFICATION REQUEST message.

15. A method performed by a radio access network node, the method comprising:
receiving from a core network a first control message containing a first information element relating to a radio terminal, wherein
the first information element indicates at least one of:
an amount of data available to the radio terminal; or
whether or not one or both of carrier aggregation and dual connectivity are required or allowed with respect to the radio terminal.

16. (canceled)

17. A core network node comprising:
at least one memory; and
at least one processor coupled to the at least one memory and configured to send to a radio access network node a first control message containing a first information element relating to a radio terminal, wherein
the first information element indicates at least one of:
an amount of data available to the radio terminal; or
whether or not one or both of carrier aggregation and dual connectivity are required or allowed with respect to the radio terminal.

18. The core network node according to claim 17, wherein the first information element at least indicates whether or not one or both of carrier aggregation and dual connectivity are required or allowed with respect to the radio terminal.

19. The core network node according to claim 17, wherein
the first information element indicates at least the amount of data available to the radio terminal, and
the amount of data is a remaining amount of data available to a user of the radio terminal until end of a current month.

20. The core network node according to claim 17, wherein the first information element is used by the radio access network node to determine whether to perform one or both of carrier aggregation and dual connectivity for the radio terminal.

21. The core network node according to claim 17, wherein the first information element is used by the radio access network node to determine whether to stop using part or all of one or more secondary cells of ongoing carrier aggregation for the radio terminal.

22-53. (canceled)
